(19) United States
(12) Patent Application Publication
(10) Pub. No.: US 2026/0230646 A1
(43) Pub. Date: Aug. 6, 2026

(54) DIRECTIONAL LIFTING IN V-DMC

(71) Applicant: QUALCOMM Incorporated, San Diego, CA (US)

(72) Inventors: Reetu Hooda, San Diego, CA (US); Geert Van der Auwera, San Diego, CA (US); Adarsh Krishnan Ramasubramonian, Irvine, CA (US); Anique Akhtar, San Diego, CA (US); Marta Karczewicz, San Diego, CA (US)

(21) Appl. No.: 19/447,946

(22) Filed: Jan. 13, 2026

Related U.S. Application Data
(60) Provisional application No. 63/745,714, filed on Jan. 15, 2025.
(60) Provisional application No. 63/775,147, filed on Mar. 20, 2025.
(60) Provisional application No. 63/781,018, filed on Mar. 31, 2025.

(51) Int. Cl. H04N 19/597; H04N 19/124; H04N 19/63; H04N 19/70

(52) U.S. Cl. CPC H04N 19/597; H04N 19/124; H04N 19/63; H04N 19/70

(57) ABSTRACT

A device for decoding a bitstream of encoded mesh data is configured to receive, in the bitstream of encoded mesh data, a first syntax element indicating a base value; receive, in the bitstream of encoded mesh data, a second syntax element indicating an exponent value; determine a delta scale value based on the base value and the exponent value; perform an inverse directional lifting transform to determine a displacement vector for a target vertex of a base mesh based on one or more of a first scale value, a second scale value, or a third scale value determined based on the delta scale value; deform the base mesh based on the displacement vector to determine a deformed base mesh; and determine a decoded mesh based on the deformed base mesh.

This application claims the benefit of:
U.S. Provisional Patent Application No. 63/781,018, filed 31 Mar. 2025;
U.S. Provisional Patent Application No. 63/775,147, filed 20 Mar. 2025; and
U.S. Provisional Patent Application No. 63/745,714, filed 15 Jan. 2025,
   the entire content of each being incorporated herein by reference.

### TECHNICAL FIELD

This disclosure relates to video-based coding of dynamic meshes.

### BACKGROUND

Meshes may be used to represent physical content of a 3-dimensional space. Meshes may have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

The techniques of this disclosure relate to encoding and decoding dynamic mesh data using an improved directional lifting transform. In an encoding process, an encoder device determines a base value and an exponent value. The encoder device determines a delta scale value based on the base and exponent values, and further determines a first scale value, a second scale value, and a third scale value from the delta scale value. A forward directional lifting transform is performed on a displacement vector for a target vertex using one or more of these determined scale values to generate one or more transform coefficients that the device encodes to generate encoded transform coefficients. The encoder device generates a bitstream to include the encoded transform coefficients, a first syntax element indicating the base value, and a second syntax element indicating the exponent value.

In a corresponding decoding process, a decoder device receives the first syntax element indicating the base value and the second syntax element indicating the exponent value. The decoder determines the delta scale value, the first scale value, the second scale value, and the third scale value based on these received values. An inverse directional lifting transform is performed to determine a displacement vector for the target vertex, where the transform relies on one or more of the first, second, or third scale values. The base mesh is subsequently deformed using the displacement vector to determine a decoded mesh.

The inverse directional lifting transform may use these determined scale values to adapt prediction and update weights. To apply the scales, the decoder determines a deviation value for a wavelet coefficient of the target vertex, for example, based on an absolute difference between a first component of the wavelet coefficient and a mean value associated with a mesh patch. The decoder selects one of the first, second, or third scale values as a selected scale value based on a comparison of this deviation value to a standard deviation value associated with the mesh patch. The decoder device then determines an adaptive weight based on the selected scale value.

The adaptive weight may be applied to a prediction step or an update step of the inverse transform. To apply the weight, the decoder first determines a coherence of the target vertex relative to a first neighboring vertex and a second neighboring vertex. This coherence calculation is simplified by comparing only a first component of the first neighboring vertex to a first component of the second neighboring vertex. Based on the coherence, a selected neighboring vertex is identified, and the adaptive weight modifies the contribution from the selected neighboring vertex during the prediction or update step.

According to an example of this disclosure, a device for decoding a bitstream of encoded mesh data includes: one or more memory units; one or more processing units implemented in circuitry, coupled to the one or more memory units, and configured to: receive, in the bitstream of encoded mesh data, a first syntax element indicating a base value; receive, in the bitstream of encoded mesh data, a second syntax element indicating an exponent value; determine a delta scale value based on the base value and the exponent value; perform an inverse directional lifting transform to determine a displacement vector for a target vertex of a base mesh based on one or more of a first scale value, a second scale value, or a third scale value determined based on the delta scale value; deform the base mesh based on the displacement vector to determine a deformed base mesh; and determine a decoded mesh based on the deformed base mesh.

According to an example of this disclosure, a method of decoding a bitstream of encoded mesh data includes: receiving, in the bitstream of encoded mesh data, a first syntax element indicating a base value; receiving, in the bitstream of encoded mesh data, a second syntax element indicating an exponent value; determining a delta scale value based on the base value and the exponent value; performing an inverse directional lifting transform to determine a displacement vector for a target vertex of a base mesh based on one or more of a first scale value, a second scale value, or a third scale value determined based on the delta scale value; deforming the base mesh based on the displacement vector to determine a deformed base mesh; and determining a decoded mesh based on the deformed base mesh.

A non-transitory computer-readable medium stores instructions that, when executed by processing circuitry, cause the processing circuitry to: receive, in a bitstream of encoded mesh data, a first syntax element indicating a base value; receive, in the bitstream of encoded mesh data, a second syntax element indicating an exponent value; determine a delta scale value based on the base value and the exponent value; perform an inverse directional lifting transform to determine a displacement vector for a target vertex of a base mesh based on one or more of a first scale value, a second scale value, or a third scale value determined based on the delta scale value; deform the base mesh based on the displacement vector to determine a deformed base mesh; and determine a decoded mesh based on the deformed base mesh.

According to an example of this disclosure, a device for generating a bitstream of encoded mesh data includes: one or more memory units; one or more processing units implemented in circuitry, coupled to the one or more memory units, and configured to: perform a plurality of forward directional lifting transforms on a displacement vector for a target vertex of a base mesh using different scale values to determine a first scale value, a second scale value, and a third scale value; determine a delta scale value based on the first scale value, the second scale value, and the third scale value; determine a base value based on the delta scale value; determine an exponent value based on the delta scale value; perform a forward directional lifting transform on the displacement vector for the target vertex of the base mesh based on one or more of the first scale value, the second scale value, or the third scale value to determine one or more transform coefficients; encode the one or more transform coefficients to determine encoded transform coefficients; and generate the bitstream of encoded mesh data, the bitstream comprising a first syntax element indicating the base value, a second syntax element indicating the exponent value, and additionally syntax elements indicating the encoded transform coefficients.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a V-DMC encoder.

FIG. 3 shows an example implementation of a V-DMC decoder.

FIG. 4 shows an example of resampling to enable efficient compression of a 2D curve.

FIG. 5 shows a displaced curve that has a subdivision structure, while approximating the shape of the original mesh.

FIG. 6 shows a block diagram of a pre-processing system.

FIG. 7 shows an example of a V-DMC intra frame encoder.

FIG. 8 shows an example of a V-DMC decoder.

FIG. 9 shows an example of a V-DMC intra frame decoder.

FIG. 10 shows an example of an arithmetic decoder for decoding displacements.

FIG. 11 shows an example of a mid-point subdivision scheme.

FIG. 12 shows scales based on a normal distribution range.

FIG. 13 is a flowchart illustrating an example process for encoding a mesh.

FIG. 14 is a flowchart illustrating an example process for decoding a compressed bitstream of mesh data.

FIG. 15 is a flowchart illustrating an example process for encoding a mesh.

FIG. 16 is a flowchart illustrating an example process for decoding a compressed bitstream of mesh data.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is, the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

The compression of displacement vectors may utilize a wavelet transform, often implemented as a lifting scheme that includes prediction and update operations. Existing approaches may use a directional lifting transform as part of this lifting scheme. This directional lifting transform adapts the prediction and update weights based on a calculated coherence between a target vertex and the neighboring vertices.

Implementations of this directional lifting, however, may suffer from computational inefficiencies and inflexible signaling. For example, the performance of the directional lifting transform is sensitive to scale thresholds used in the transform, but these thresholds may be hard-coded in a decoder, which prevents optimization by an encoder. Other calculations, such as determining a Z-score, may rely on computationally expensive division operations, and coherence calculations may perform redundant dot product operations. Signaling logic may also lack flexibility, such as preventing a tool from being enabled at a patch level. In other examples, parameters for merge and inter meshpatches may not be delta-coded, reducing compression efficiency, and mean values may be signaled repetitively.

The techniques of this disclosure relate to encoding and decoding dynamic mesh data using an improved directional lifting transform and signaling process. In an encoding process, an encoder device determines a base value and an exponent value. The encoder device determines a delta scale value based on the base and exponent values, and further determines a first scale value, a second scale value, and a third scale value from the delta scale value. A forward directional lifting transform is performed on a displacement vector for a target vertex using one or more of these determined scale values to generate one or more transform coefficients. The encoder device generates a bitstream to include the encoded transform coefficients, a first syntax element indicating the base value, and a second syntax element indicating the exponent value.

In a corresponding decoding process, a decoder device receives the first syntax element indicating the base value and the second syntax element indicating the exponent value. The decoder device determines the delta scale value, the first scale value, the second scale value, and the third scale value based on these received values. An inverse directional lifting transform is performed to determine a displacement vector for the target vertex, where the transform relies on one or more of the first, second, or third scale values. The base mesh is subsequently deformed using the displacement vector to determine a decoded mesh.

The inverse directional lifting transform may use these determined scale values to adapt prediction and update weights. To apply the scales, the decoder determines a deviation value for a wavelet coefficient of the target vertex, for example, based on an absolute difference between a first component of the wavelet coefficient and a mean value associated with a mesh patch. The decoder selects one of the first, second, or third scale values as a selected scale value based on a comparison of this deviation value to a standard deviation value associated with the mesh patch. The decoder device then determines an adaptive weight based on the selected scale value.

The adaptive weight may be applied to a prediction step or an update step of the inverse transform. To apply the weight, the decoder first determines a coherence of the target vertex relative to a first neighboring vertex and a second neighboring vertex. This coherence calculation is simplified by comparing only a first component of the first neighboring vertex to a first component of the second neighboring vertex. Based on the coherence, a selected neighboring vertex is identified, and the adaptive weight modifies the contribution from the selected neighboring vertex during the prediction or update step.

Further signaling improvements may be achieved, by for instance, adding a patch-level flag to enable or disable directional lifting for a specific meshpatch, independent of sequence-level parameters. Additionally, parameters for merge and inter meshpatches may be delta-coded relative to a predictor. A mean value determined for a lifting offset tool may also be reused for the directional lifting transform. In some examples, the scale values may be signaled using an alternative delta-based approach to minimize metadata overhead.

The techniques of this disclosure address the shortcomings of existing approaches. For instance, in accordance with examples described in this disclosure, signaling the scale values via a base and exponent, or via a delta-based approach, replaces the fixed, hard-coded thresholds. This provides a generalized decoder design where the performance-sensitive scales may be optimized and signaled efficiently. The techniques also introduce computational simplifications to the directional lifting algorithm, reducing complexity and increasing processing speed. This process avoids an expensive division operation by comparing the deviation value (e.g., a z-score numerator) directly to the standard deviation value. The simplified coherence calculation avoids a redundant dot product operation, and the check for equal coherence may also be removed to further reduce complexity. The enhanced signaling provides greater flexibility and compression efficiency, reduces bitstream size, and avoids repetitive signaling.

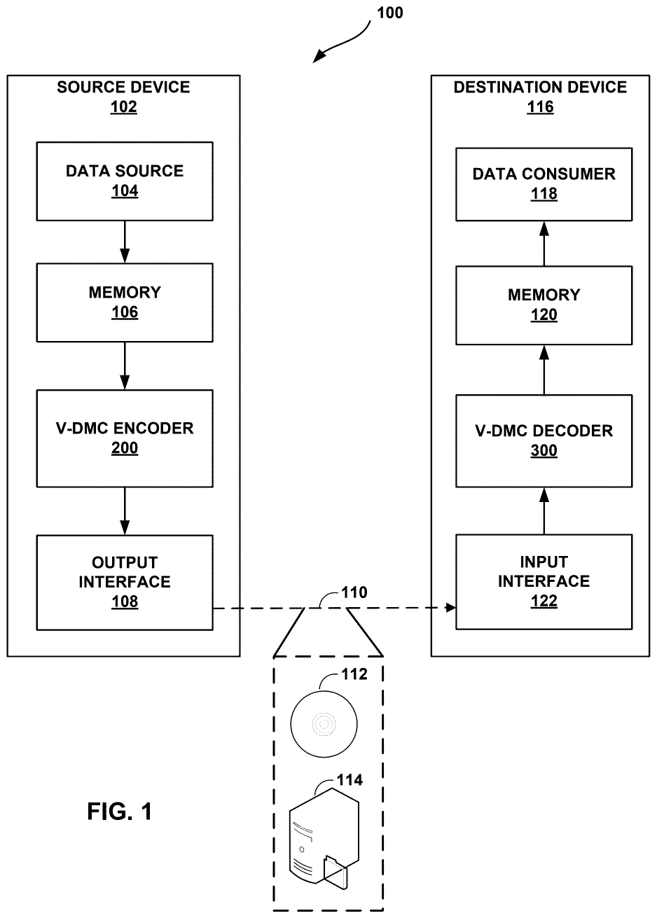

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (e.g., raw, unencoded data) and may provide a sequential series of “frames” of the data to V-DMC encoder 200, which encodes data for the frames. Data source 104 may, for example, execute a framework or platform for generating graphics for video games, augmented reality, simulations, or any other such use case. Data source 104 of source device 102 may include a graphics engine that generates raw mesh data from any combination of one or more sensors configured to obtain real-world data. Examples of such sensors include cameras, 2D scanners, 3D scanners, light detection and ranging (LIDAR) devices, video cameras, ultrasonic sensors, infrared sensors, inertial measurement sensors, sonar sensors, pressure sensors, thermal imaging sensors, magnetic sensors, laser range finders, photodetectors, and the like. In other examples, the graphics engine may generate meshes that are entirely computer generated, i.e., not representative of a real world scene, using modeling, simulation, animation, generative adversarial networks, and the like. In yet other examples, data source 104 may not include a graphics engine, but instead, may obtain the mesh data from a storage unit or other device.

Regardless of whether the mesh data is based on real-world sensor data, entirely computer generated, obtained from an external source, or some combination thereof, V-DMC encoder 200 encodes the mesh data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure addresses various improvements of the displacement vector quantization process in the video-based coding of dynamic meshes (V-DMC) technology that is being standardized in MPEG WG7 (3DGH).

The MPEG working group 7 (WG7), also known as the 3D graphics and haptics coding group (3DGH), is currently standardizing the coding of dynamic mesh representations (V-DMC) targeting XR use cases. The current test model is based on the call for proposals result, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, and encompasses the pre-processing of the input meshes into approximated meshes with typically fewer vertices named the base meshes, which are coded with a static mesh coder such as Google Draco, MPEG's edge breaker implementation, etc. In addition, the encoder may estimate the motion of the base mesh vertices and code the motion vectors into the bitstream. The reconstructed base meshes may be subdivided into finer meshes with additional vertices and, hence, additional triangles. The encoder may refine the positions of the subdivided mesh vertices to approximate the original mesh. The refinements or vertex displacement vectors may be coded into the bitstream. In the current test model, the displacement vectors are wavelet transformed (lifting scheme), quantized, and the coefficients are either packed into a 2D frame or directly coded with an arithmetic coder after inter prediction. The sequence of video frames is coded with a typical video coder, for example, the High Efficiency Video Coding (HEVC) Standard or the Versatile Video Coding (VVC) standard, into the bitstream. In addition, the sequence of texture frames is coded with a video coder.

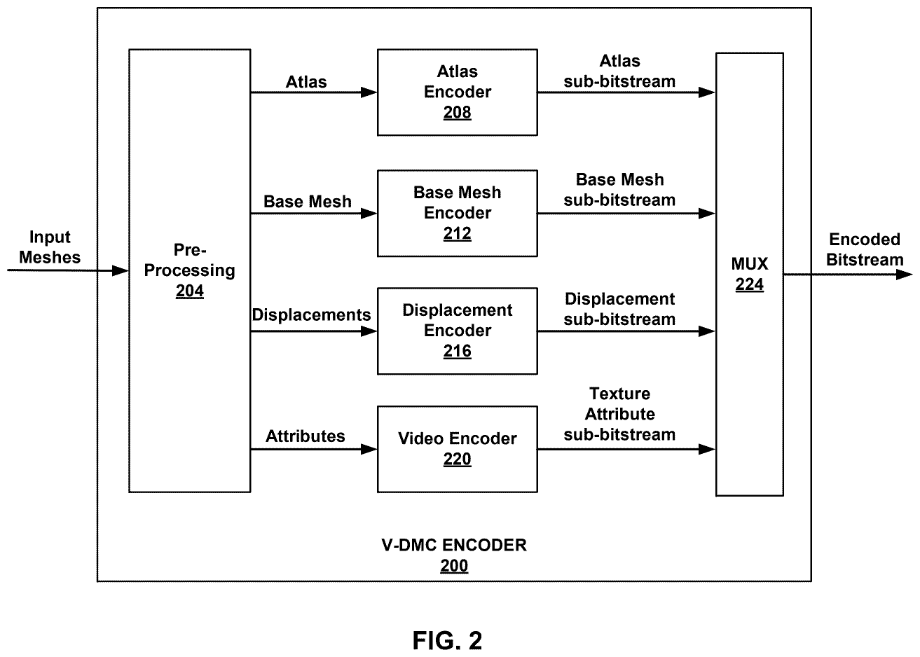

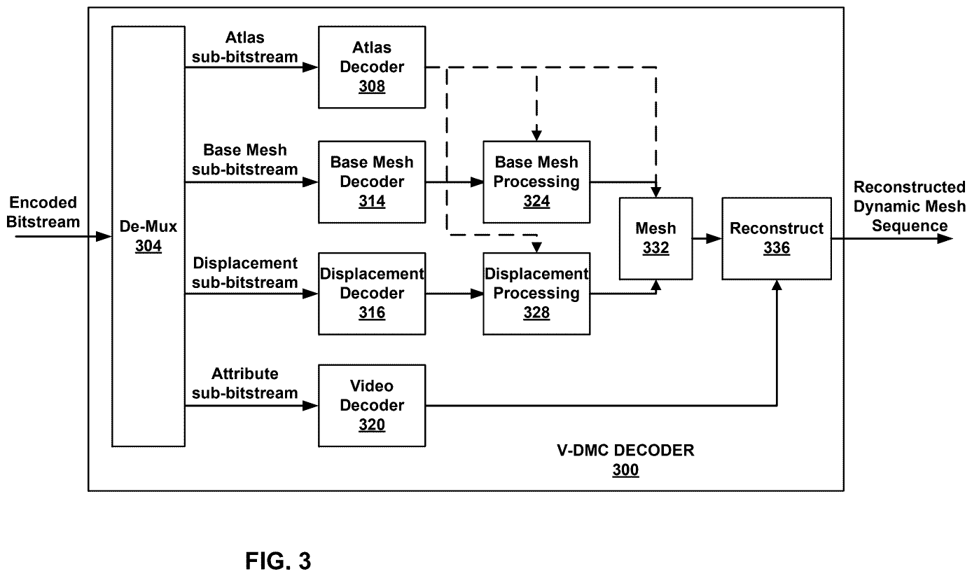

FIGS. 2 and 3 show the overall system model for the current V-DMC test model (TM) encoder (V-DMC encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, video encoder 220, and multiplexer (MUX) 224. Pre-processing unit 204 receives an input mesh sequence and generates atlas parameters, a base mesh, the displacement vectors, and the texture attribute maps. Atlas encoder 208 encodes the atlas parameters. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as the High Efficiency Video Coding (HEVC) Standard or the Versatile Video Coding (VVC) standard. MUX 224 combines the atlas sub-bitstream produced by atlas encoder 208, the base mesh sub-bitstream produced by base mesh encoder 212, the displacement sub-bitstream produced by displacement encoder 216, and the texture attribute sub-bitstream produced by video encoder 220 into a single encoded bitstream that may be stored or transmitted.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

Base mesh encoder 212 may be configured to implement the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include one or more submeshes.

Base mesh encoder 212 may process connected components. Connected components include a cluster of triangles that are connected by their neighbors. A submesh can have one or more connected components. Base mesh encoder 212 may encode one “connected component” at a time for connectivity and attributes encoding and then performs entropy encoding on all “connected components”.

Base mesh encoder 212 defines and categorizes the input base mesh into the connectivity and attributes. The geometry and texture coordinates (UV coordinates) are categorized as attributes.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

The following description will detail the displacement vector coding in the current V-DMC test model and WD 2.0. Additionally, the coding of the base mesh motion field is described.

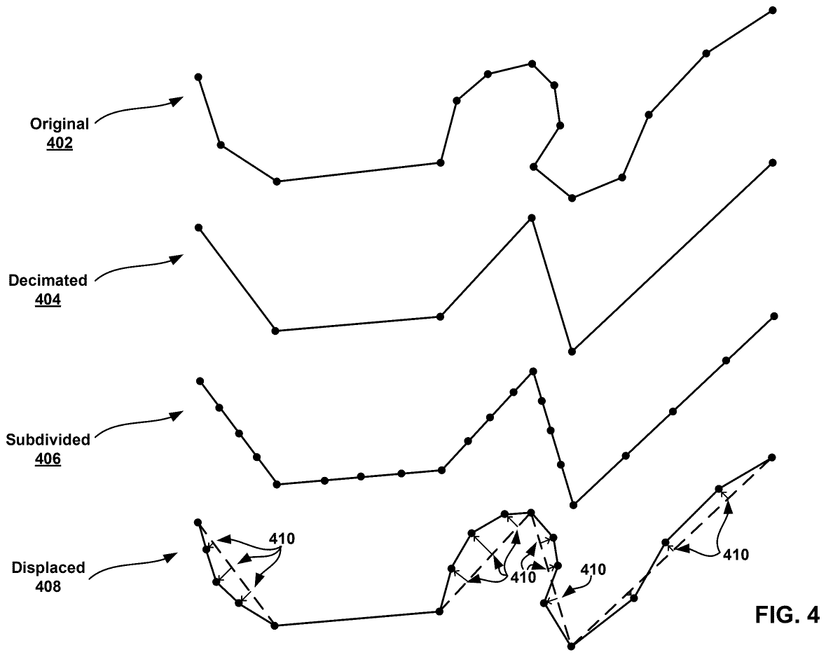

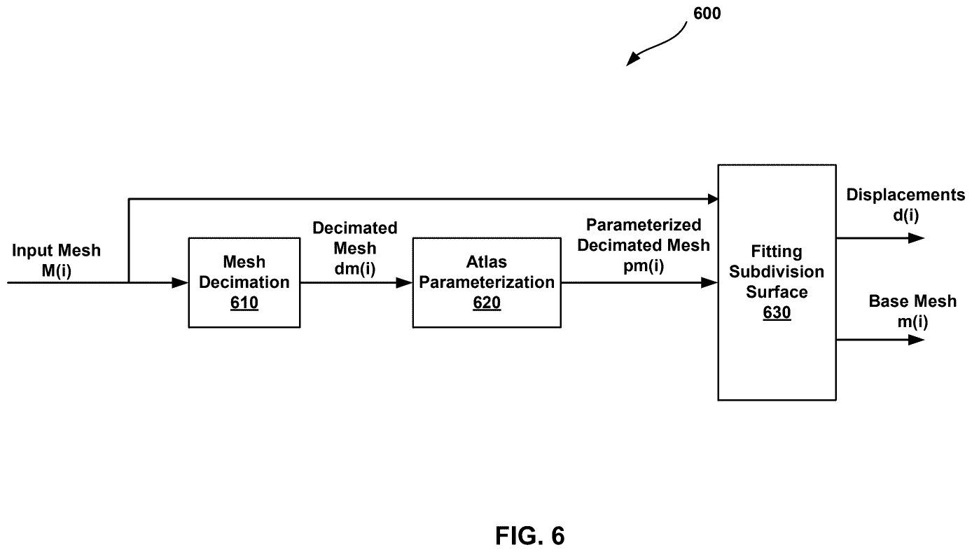

A pre-processing system, such as pre-processing system 600 described with respect to FIG. 6, may be configured to perform preprocessing on an input mesh M(i). FIG. 4 illustrates the basic idea behind the proposed pre-processing scheme using a 2D curve. The same concepts may be applied to the input 3D mesh M(i) to produce a base mesh m(i) and a displacement field d(i).

In FIG. 4, the input 2D curve (represented by a 2D polyline), referred to as original curve 402, is first downsampled to generate a base curve/polyline, referred to as the decimated curve 404. A subdivision scheme, such as that described in Garland et al, Surface Simplification Using Quadric Error Metrics (https://www.cs.cmu.edu/~garland/Papers/quadrics.pdf), is then applied to the decimated polyline to generate a subdivided curve 406. For instance, in FIG. 4, a subdivision scheme using an iterative interpolation scheme is applied. The subdivision scheme inserts at each iteration a new point in the middle of each edge of the polyline. In the example illustrated, two subdivision iterations were applied.

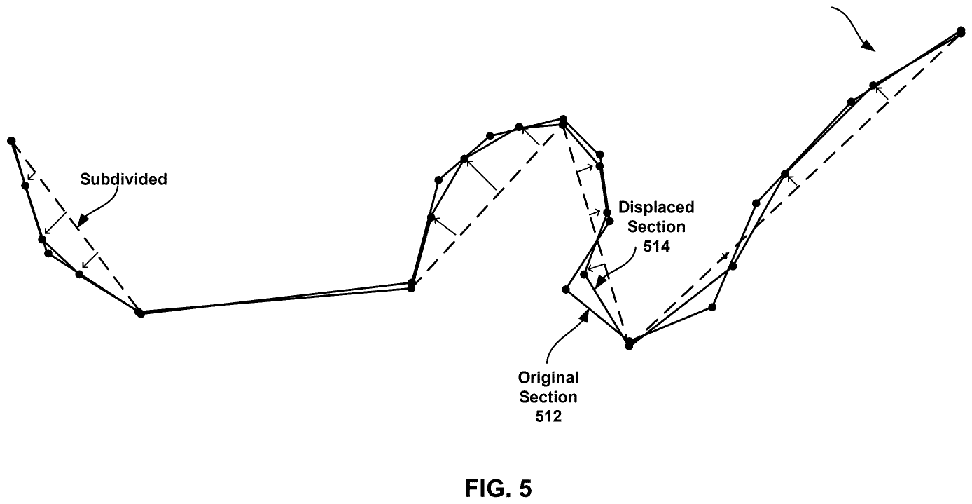

The proposed scheme is independent of the chosen subdivision scheme and may be combined with other subdivision schemes. The subdivided polyline is then deformed, or displaced, to get a better approximation of the original curve. This better approximation is displaced curve 408 in FIG. 4. Displacement vectors (arrows 410 in FIG. 4) are computed for each vertex of the subdivided mesh such that the shape of the displaced curve is as close as possible to the shape of the original curve (see FIG. 5). As illustrated by section 514 of displaced curve 408 and section 512 of original curve 402, for example, the displaced curve may not perfectly match the original curve.

An advantage of the subdivided curve is that the subdivided curve may have a subdivision structure that allows for efficient compression, while offering a faithful approximation of the original curve. The compression efficiency is obtained thanks to the following properties:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

FIG. 6 shows a block diagram of pre-processing system 600 which may be included in V-DMC encoder 200 or may be separate from V-DMC encoder 200. Pre-processing system 600 represents an example implementation of pre-processing unit 204 as described with respect to FIG. 2. In the example of FIG. 6, pre-processing system 600 includes mesh decimation unit 610, atlas parameterization unit 620, and subdivision surface fitting unit 630.

Mesh decimation unit 610 uses a simplification technique to decimate the input mesh M(i) and produce the decimated mesh dm(i). The decimated mesh dm(i) is then re-parameterized by atlas parameterization unit 620, which may for example use the UVAtlas tool. The generated mesh is denoted as pm(i). The UVAtlas tool considers only the geometry information of the decimated mesh dm(i) when computing the atlas parameterization, which is likely sub-optimal for compression purposes. Better parameterization schemes or tools may also be considered with the proposed framework.

Applying re-parameterization to the input mesh makes it possible to generate a lower number of patches. This reduces parameterization discontinuities and may lead to better RD performance. Subdivision surface fitting unit 630 takes as input the re-parameterized mesh pm(i) and the input mesh M(i) and produces the base mesh m(i) together with a set of displacements d(i). First, pm(i) is subdivided by applying the subdivision scheme. The displacement field d(i) is computed by determining for each vertex of the subdivided mesh the nearest point on the surface of the original mesh M(i).

For the Random Access (RA) condition, a temporally consistent re-meshing may be computed by considering the base mesh m (j) of a reference frame with index j as the input for subdivision surface fitting unit 630. This makes it possible to produce the same subdivision structure for the current mesh M′(i) as the one computed for the reference mesh M′(j). Such a re-meshing process makes it possible to skip the encoding of the base mesh m(i) and re-use the base mesh m (j) associated with the reference frame M (j). This may also enable better temporal prediction for both the attribute and geometry information. More precisely, a motion field f (i) describing how to move the vertices of m (j) to match the positions of m(i) is computed and encoded. Note that such time-consistent re-meshing is not always possible. The proposed system compares the distortion obtained with and without the temporal consistency constraint and chooses the mode that offers the best RD compromise.

Note that the pre-processing system is not normative and may be replaced by any other system that produces displaced subdivision surfaces. A possible efficient implementation would constrain the 3D reconstruction unit to directly generate displaced subdivision surface and avoids the need for such pre-processing.

V-DMC encoder 200 and V-DMC decoder 300 may be configured to perform displacements coding, including video-based coding. Depending on the application and the targeted bitrate/visual quality, the encoder may optionally encode a set of displacement vectors associated with the subdivided mesh vertices, referred to as the displacement field d(i), as described in this section.

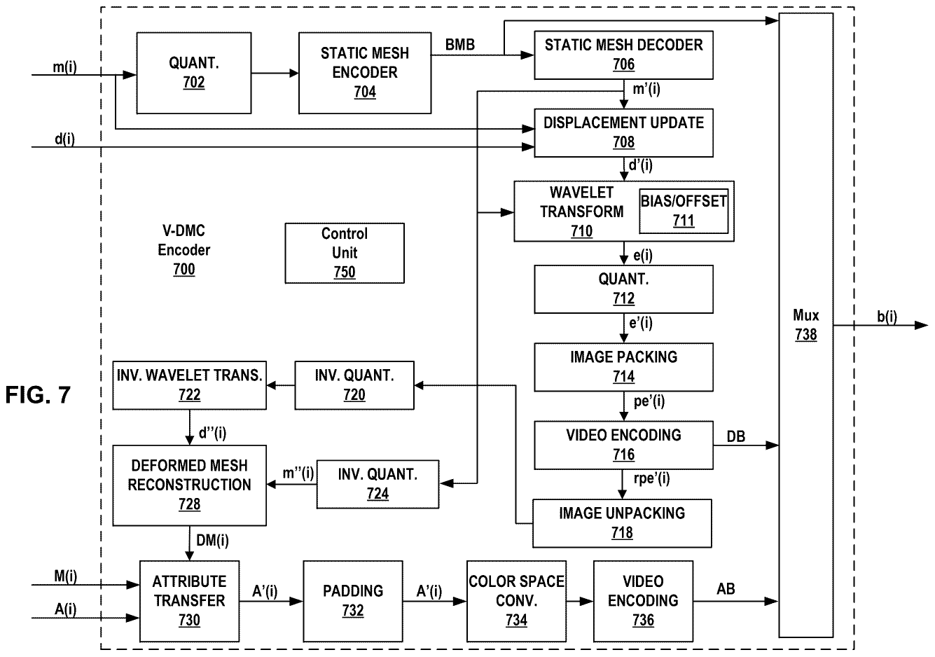

FIG. 7 shows V-DMC encoder 700, which is configured to implement an intra encoding process. V-DMC encoder 700 represents an example implementation of V-DMC encoder 200.

FIG. 7 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e (i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

V-DMC encoder 200 receives base mesh m(i) and displacements d(i), for example from pre-processing system 600 of FIG. 6. V-DMC encoder 200 also retrieves mesh M(i) and attribute map A(i).

Quantization unit 702 quantizes the base mesh, and static mesh encoder 704 encodes the quantized base mesh to generate a compressed base mesh bitstream. Static mesh decoder 706 then decodes the encoded base mesh. To the extent the encoding of the base mesh by static mesh encoder 704 is lossy, this encoding followed by decoding may determine the loss so that V-DMC encoder 700 may determine displacement vectors that reduce or minimize the loss.

Displacement update unit 708 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 710 applies a wavelet transform to d′(i) to generate a set of wavelet coefficients. The scheme is generally agnostic to the transform applied and may leverage any other transform, including the identity transform. In accordance with the techniques of this disclosure, transform unit 710 includes a bias/offset determination unit 711. Bias/offset determination unit 711 may be configured to transform a set of displacement vectors to determine a set of transform coefficients; determine a bias value for the set of transform coefficients; determine an offset value based on the bias value for the set of transform coefficients; and subtract the offset value from the set of transform coefficients to determine bias-adjusted transform coefficients.

Quantization unit 712 quantizes wavelet coefficients, e.g., the bias-adjusted transform coefficients determined by bias/offset determination unit 711, and image packing unit 714 packs the quantized wavelet coefficients into a 2D image/video that can be compressed using a traditional image/video encoder in the same spirit as video-based point cloud compression (V-PCC) to generate a displacement bitstream.

Attribute transfer unit 730 converts the original attribute map A(i) to an updated attribute map that corresponds to the reconstructed deformed mesh DM(i). Padding unit 732 pads the updated attributed map by, for example, filling patches of the frame that have empty samples with interpolated samples that may improve coding efficiency and reduce artifacts. Color space conversion unit 734 converts the attribute map into a different color space, and video encoding unit 736 encodes the updated attribute map in the new color space, using for example a video codec, to generate an attribute bitstream.

Multiplexer 738 combines the compressed attribute bitstream, compressed displacement bitstream, and compressed base mesh bitstream into a single compressed bitstream.

Image unpacking unit 718 and inverse quantization unit 720 apply image unpacking and inverse quantization to the reconstructed packed quantized wavelet coefficients generated by video encoding unit 716 to obtain the reconstructed version of the wavelet coefficients. Inverse wavelet transform unit 722 applies an inverse wavelet transform to the reconstructed wavelet coefficient to determine reconstructed displacements d″(i).

Inverse quantization unit 724 applies an inverse quantization to the reconstructed quantized base mesh m′(i) to obtain a reconstructed base mesh m″(i). Deformed mesh reconstruction unit 728 subdivides m″(i) and applies the reconstructed displacements d′(i) to its vertices to obtain the reconstructed deformed mesh DM(i).

Image unpacking unit 718, inverse quantization unit 720, inverse wavelet transform unit 722, and deformed mesh reconstruction unit 728 represent a displacement decoding loop. Inverse quantization unit 724 and deformed mesh reconstruction unit 728 represent a base mesh decoding loop. V-DMC encoder 700 includes the displacement decoding loop and the base mesh decoding loop so that V-DMC encoder 700 can make encoding decisions, such as determining an acceptable rate-distortion tradeoff, based on the same decoded mesh that a mesh decoder will generate, which may include distortion due to the quantization and transforms. V-DMC encoder 700 may also use decoded versions of the base mesh, reconstructed mesh, and displacements for encoding subsequent base meshes and displacements.

Control unit 750 generally represents the decision making functionality of V-DMC encoder 700. During an encoding process, control unit 750 may, for example, make determinations with respect to mode selection, rate allocation, quality control, and other such decisions.

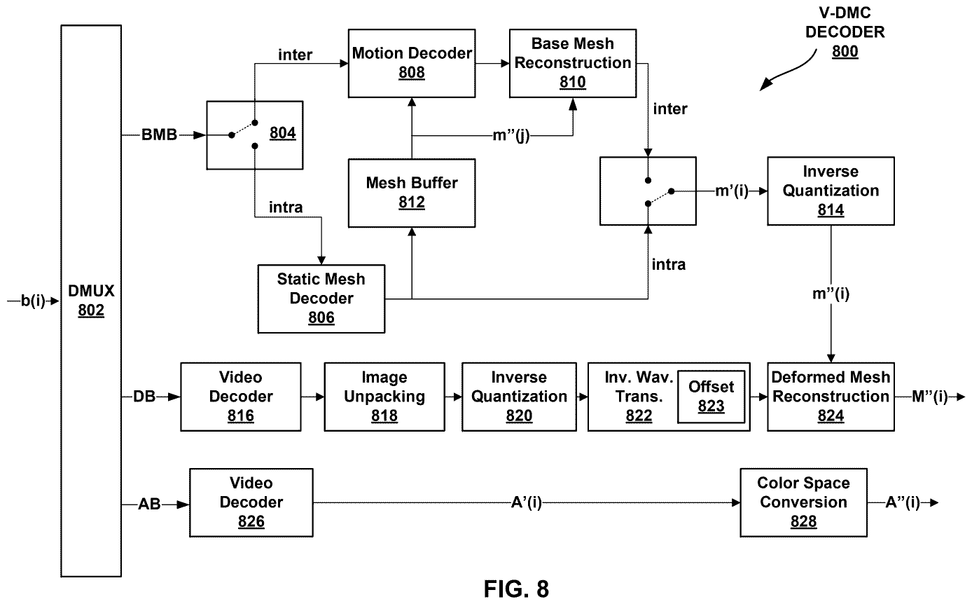

FIG. 8 shows V-DMC decoder 800, which may be configured to perform either intra- or inter-decoding. V-DMC decoder 800 represents an example implementation of V-DMC decoder 300. The processes described with respect to FIG. 8 may also be performed, in full or in part, by V-DMC encoder 200.

V-DMC decoder 800 includes demultiplexer (DMUX) 802, which receives compressed bitstream b (i) and separates the compressed bitstream into a base mesh bitstream (BMB), a displacement bitstream (DB), and an attribute bitstream (AB). Mode select unit 804 determines if the base mesh data is encoded in an intra mode or an inter mode. If the base mesh is encoded in an intra mode, then static mesh decoder 806 decodes the mesh data without reliance on any previously decoded meshes. If the base mesh is encoded in an inter mode, then motion decoder 808 decodes motion, and base mesh reconstruction unit 810 applies the motion to an already decoded mesh (m″(j)) stored in mesh buffer 812 to determine a reconstructed quantized base mesh (m′(i))). Inverse quantization unit 814 applies an inverse quantization to the reconstructed quantized base mesh to determine a reconstructed base mesh (m″(i)).

Video decoder 816 decodes the displacement bitstream to determine a set or frame of quantized transform coefficients. Image unpacking unit 818 unpacks the quantized transform coefficients. For example, video decoder 816 may decode the quantized transform coefficients into a frame, where the quantized transform coefficients are organized into blocks with particular scanning orders. Image unpacking unit 818 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 820 inverse quantizes, e.g., inverse scales, quantized transform coefficients to determine de-quantized transform coefficients. Inverse wavelet transform unit 822 applies an inverse transform to the de-quantized transform coefficients to determine a set of displacement vectors. Inverse wavelet transform unit 822 includes offset unit 823. Offset unit 823 is configured to determine an offset value based on one or more syntax elements and apply the offset to a set of transform coefficients to determine a set of updated transform coefficients before inverse wavelet transform unit 822 applies the inverse transform.

Deformed mesh reconstruction unit 824 deforms the reconstructed base mesh using the decoded displacement vectors to determine a decoded mesh (M″(i)). Video decoder 826 decodes the attribute bitstream to determine decoded attribute values (A′(i)), and color space conversion unit 828 converts the decoded attribute values into a desired color space to determine final attribute values (A″(i)). The final attribute values correspond to attributes, such as color or texture, for the vertices of the decoded mesh.

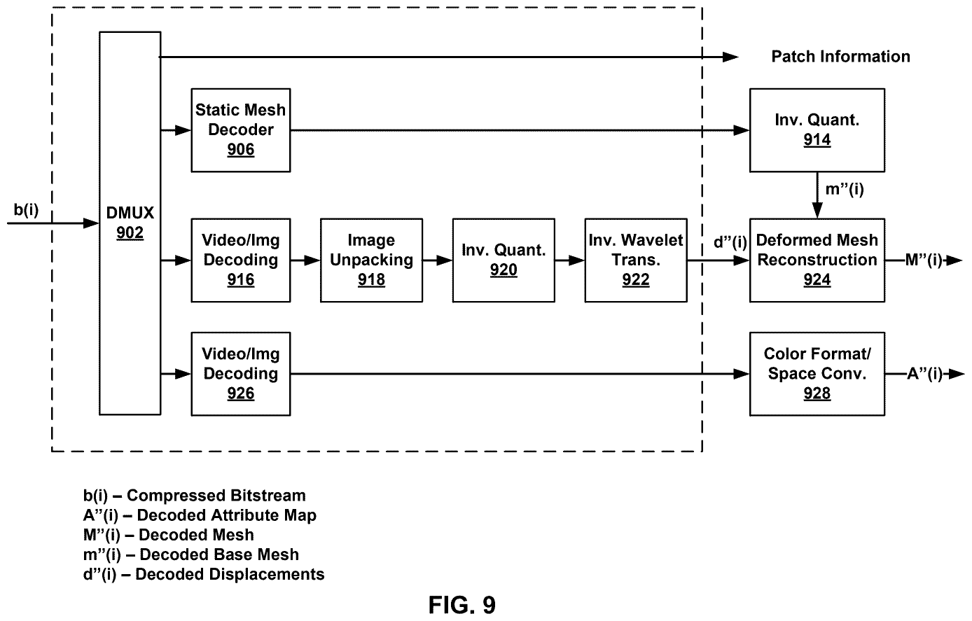

FIG. 9 shows a block diagram of an intra decoder which may, for example, be part of V-DMC decoder 300. De-multiplexer (DMUX) 902 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 902 feeds the mesh sub-stream to static mesh decoder 906 to generate the reconstructed quantized base mesh m′(i). Inverse quantization unit 914 inverse quantizes the base mesh to determine the decoded base mesh m″(i). Video/image decoding unit 916 decodes the displacement sub-stream, and image unpacking unit 918 unpacks the image/video to determine quantized transform coefficients, e.g., wavelet coefficients. Inverse quantization unit 920 inverse quantizes the quantized transform coefficients to determine dequantized transform coefficients. Inverse transform unit 922 generates the decoded displacement field d″(i) by applying the inverse transform to the unquantized coefficients. Deformed mesh reconstruction unit 924 generates the final decoded mesh (M″(i)) by applying the reconstruction process to the decoded base mesh m″(i) and by adding the decoded displacement field d″(i). The attribute sub-stream is directly decoded by video/image decoding unit 926 to generate an attribute map A″(i). Color format/space conversion unit 928 may convert the attribute map into a different format or color space.

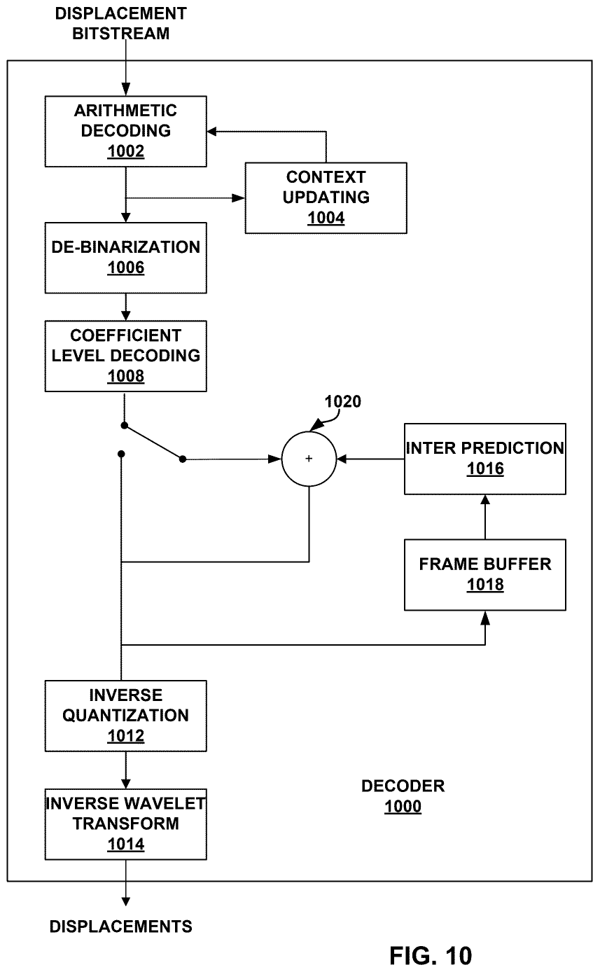

As an addition or alternative to packing the quantized wavelet coefficients in frames and coding as images or video, a scheme that directly codes the quantized wavelet coefficients with a block-based arithmetic coder may also be used. This scheme is illustrated in FIG. 10. The decoded quantized wavelet coefficients are inter predicted from the reference buffer, which contains quantized wavelet coefficients from prior frames, for example, the preceding frame. In the example of FIG. 10, decoder 1000 performs context-based arithmetic decoding 1002 of a displacement bitstream based on a context update 1004. Decoder 1000 performs de-binarization 1006 on the context decoded bitstream to determine values for syntax elements and performs coefficient level decoding 1008 on the syntax elements. For intra coded displacements, decoder 1000 performs inverse quantization 1012 on the coefficient levels to determine de-quantized coefficient levels, and then performs an inverse wavelet transform 1014 on the de-quantized coefficient levels to determine the displacements. For inter coded displacements, decoder 1000 performs inter prediction 1016 using reference frames stored in a frame buffer 1018 and adds 1020 the prediction values to the coefficient levels to determine final coefficient levels. Decoder 1000 then performs inverse quantization 1012 on the final coefficient levels to determine de-quantized coefficient levels, and then performs an inverse wavelet transform 1014 on the de-quantized coefficient levels to determine the displacements.

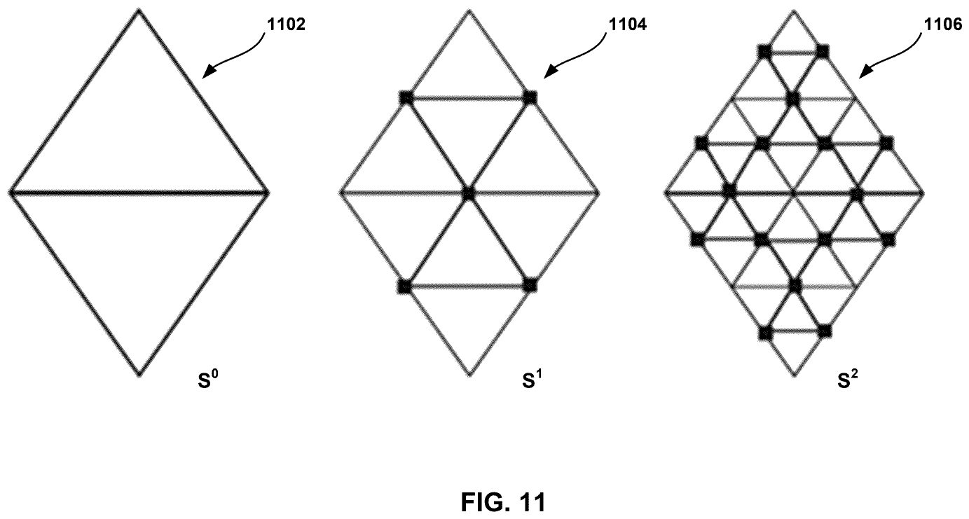

V-DMC encoder 200 and V-DMC decoder 300 may be configured to implement a subdivision scheme. Various subdivision schemes could be considered. A possible solution is the mid-point subdivision scheme, which at each subdivision iteration subdivides each triangle into four sub-triangles as described in FIG. 11. New vertices are introduced in the middle of each edge. In the example, FIG. 11, triangles 1102 are subdivided to obtain triangles 1104, and triangles 1104 are subdivided to obtain triangles 1106. The subdivision process is applied independently to the geometry and to the texture coordinates since the connectivity for the geometry and for the texture coordinates is usually different. Using the sub-division scheme, V-DMC encoder 200 and V-DMC decoder 300 compute the position Pos(v₁₂) of a newly introduced vertex 112 at the center of an edge (v₁, v₂), as follows:

$$P o s ( {v}_{12} ) = \frac{1}{2} ( P o s ( {v}_{1} ) + P o s ( {v}_{2} ) ) ,$$

where Pos(v₁) and Pos(v₂) are the positions of the vertices v₁ and v₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(v₁₂), N(v₁), and N(v₂) are the normal vectors associated with the vertices v₁₂, v₁, and v₂, respectively.
∥x∥ is the norm2 of the vector x.

V-DMC encoder 200 and V-DMC decoder 300 may be configured to apply wavelet transforms. Various wavelet transforms may be applied. The results reported for CfP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where
v is the vertex introduced in the middle of the edge (v₁, v₂), and
Signal(v), Signal(v₁), and Signal(v₂) are the values of the geometry/vertex attribute signals at the vertices v, v₁, and v₂, respectively.

The updated process is as follows:

$$Signal ( v ) ← Signal ( v ) + \frac{1}{8} {\sum }_{w ∈ {v}^{*}} Signal ( w )$$

where v* is the set of neighboring vertices of the vertex v.

The scheme may allow to skip the update process. The wavelet coefficients could be quantized e.g., by using a uniform quantizer with a dead zone.

Local versus canonical coordinate systems for displacements will now be discussed. The displacement field d(i) is defined in the same cartesian coordinate system as the input mesh. A possible optimization is to transform d(i) from this canonical coordinate system to a local coordinate system, which is defined by the normal to the subdivided mesh at each vertex.

A potential advantage of considering a local coordinate system for the displacements is the possibility to quantize more heavily the tangential components of the displacements compared to the normal component. In fact, the normal component of the displacement has more significant impact on the reconstructed mesh quality than the two tangential components.

V-DMC encoder 200 and V-DMC decoder 300 may be configured to implement packing of wavelet coefficients. The following scheme is used to pack the wavelet coefficients into a 2D image:
Traverse the coefficients from low to high frequency.
For each coefficient, determine the index of the N×M pixel block (e.g., N=M=16) in which the coefficient is to be stored following a raster order for blocks.
The position within the N×M pixel block may be computed by using a Morton order to maximize locality.

Other packing schemes could be used (e.g., zigzag order, raster order). The encoder could explicitly signal in the bitstream the used packing scheme (e.g., atlas sequence parameters). This could be done at patch, patch group, tile, or sequence level.

V-DMC encoder 200 may be configured to perform displacement video encoding. The proposed scheme is agnostic of which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

V-DMC encoder 200 and V-DMC decoder 300 may be configured to execute a directional lifting algorithm.

| | |
|---|---|
| a. | As part of the preprocessing step, in lifting transform, prediction is |
| | performed twice. First preprocessing prediction is used to calculate |
| | μ and σ across all vertices of the signal signal[v]. |
| b. | Then directional lifting is applied after both, the main prediction |
| | and update operation in lifting transform in steps as listed |
| | from c. onwards. |
| 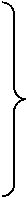 | When v1 and v2 are the neighboring vertices and v is the target vertex, coherence is computed as follows: $\begin{matrix}signal [ v ] \cdot signal [ v 1 ] > signal [ v ] \cdot signal [ v 2 ] \text{---→} 0 \\ signal [ v ] \cdot signal [ v 1 ] == signal [ v ] \cdot signal [ v 2 ] \text{---→} 2 \\ signal [ v ] \cdot signal [ v 1 ] < signal [ v ] \cdot signal [ v 2 ] \text{---→} 1\end{matrix} Coherence$ |
| d. | Z_{score} is computed as abs(signal[v] − μ)/σ |
| e. | The value k is selected based on Z_{score} as follows: |
| | $\begin{matrix}k = 0.5 if {Z}_{s c o r e} < 1 \\ = 0.75 if {Z}_{s c o r e} < 2 \\ = 0.95 otherwise\end{matrix}$ |
| f. | Scale is calculated as: - |
| | $\begin{matrix}{U}_{s c a l e} = {( k * 0.1 + 0.9 )}^{⋀} 2 - 1 for update \\ {P}_{s c a l e} = {( k * 0.1 + 0.9 )}^{⋀} 1 - 1 for prediction\end{matrix}$ |
| g. | Apply directional weight to prediction step |
| | $signal [ v ] = signal [ v ] - {P}_{scale} * signal [ v 1 ] , if coherence = 1$ $signal [ v ] = signal [ v ] - {P}_{scale} * signal [ v 2 ] , if coherence = 0$ |
| h. | Apply directional weight to update step |
| | $signal [ v 1 ] = signal [ v 1 ] + {U}_{scale} * signal [ v ] , if coherence = 1$ $signal [ v 2 ] = signal [ v 2 ] + {U}_{scale} * signal [ v ] , if coherence = 0$ |

The following is example code for inverse directional lifting:

```
template<class T1, class T2>
void
applyDirectionalWeights(std::vector<T1>& signal,
  int32_t v, int32_t v1, int32_t v2,
  const std::vector<double> dirScale,
```

| | |
|---|---|
| const T2 | predWeight, |
| const T2 | updateWeight1, |
| const T2 | updateWeight2, |
| const bool | isPredStep, |
| const bool | isInverse) { |

```
  auto d1 = updateWeight1 * signal[v];
  auto d2 = updateWeight2 * signal[v];
  auto ps1 = predWeight * signal[v1];
  auto ps2 = predWeight * signal[v2];
  auto mean_global = dirScale[0];
  auto std_global = dirScale[v1];
  if (isInverse) {
    auto signal_v_rec = isPredStep ? signal[v] : (signal[v] + predWeight * (signal[v1] +
signal[v2]));
    int8_t coherence =
      computeCoherence(signal_v_rec, signal[v1], signal[v2]);
    double deviation = signal_v_rec[0] − mean_global;
    double z_score = std::abs(deviation / std_global);
    auto weight = (z_score < 1) ? 0.5 : (z_score < 2) ? 0.75 : 0.95;
    auto weight_normalized =
```

pow((weight * 0.1 + 0.9), (isPredStep == false ? 2 : 1)) − 1.;

```
    if (coherence <= 1) {
      if (isPredStep) {
        auto ps = coherence ? ps1 : ps2;
        signal[v] += weight_normalized * ps;
      }
      else }
        auto ps = coherence ? v1 : v2;
        auto d = ps == v1 ? d1 : d2;
        signal[ps] −= weight_normalized * d;
      }
    }
  }
}
```

This disclosure addresses various problems. A first set of problems that may be addressed by techniques described in this disclosure is directed to directional lifting algorithm issues. Coherence is deduced using the dot product of two neighboring vertices, while the directional lifting is applied only to the first component (normal vector) of the displacement vector. In the coherence calculation, three conditions are tested. Among the three conditions, the likelihood of the dot product of neighboring vertices with the target vertex being equal is very low, making the check redundant. A scale is chosen based on a value ‘k’ which is selected based on the range that the z-score falls into, making the process a two-step calculation with multiple constants that are hard-coded. A division by standard deviation to calculate the z-score is used, which is essentially compared to choose the value ‘k’, making for an expensive operation that can be simplified.

A second set of problems that may be addressed by techniques described in this disclosure is directed to directional lifting parameters signaling issues. VDMC's updated committee draft (CD), Text of ISO/IEC DIS 23090-29 Video-based mesh coding, ISO/IEC JTC1/SC29/WG7, N01027, November 2024, is referenced in this disclosure for the intra meshpatch, merge meshpatch, inter meshpatch, and lifting transform parameters syntaxes and is incorporated herein by reference. The following issues have been identified and are being addressed by the techniques of this disclosure. If at the Sequence Parameter Set (SPS) level, the transform type is none, then the directional lifting flag may be disabled, and when the transform type is overridden at the meshpatch level, the directional lifting transform cannot be enabled. Also, if the subdivision process is overridden at the meshpatch level, for example to mid/mid/loop, then the directional lifting transform cannot be disabled at the meshpatch level.

Additionally, the performance is sensitive to the three threshold ranges used to calculate the value of ‘k’, but these ranges are currently neither optimized nor signaled. Also, there is flexibility to enable or disable this tool per Level of Detail (LOD), which introduces too many update weight cases in the lifting transform. Directional lifting scale parameters are two but are sent as one parameter with an index of 2 in the meshpatch, inter meshpatch, and merge meshpatch. The directional lifting parameters are sent as fractional values, but only the numerator with a precision of 2 is sent, and the decoder uses a fixed value of 100 to calculate the scale. The directional lifting parameters are not delta-coded for merge and inter meshpatches. Finally, the lifting offset tool and the directional lifting transform signal a mean of the same signal but signal the mean separately, causing repetitive signaling.

A dot product for coherence calculation will now be discussed. A problem with current implementations is that coherence is deduced using a dot product of two neighboring vertices while the directional lifting is applied only to the first component (normal vector) of displacement vector. A simplified solution may be that if signal_v1 and signal_v2 are neighboring vertices and the signal is the target vertex, then the coherence may be computed as follows:

```
computeCoherence(const T signal, const T signal_v1, const T signal_v2) {
  auto dotproduct_v1 = signal[0] * signal_v1[0] + signal[1] * signal_v1[1]
        + signal[2] * signal_v1[2];
  auto dotproduct_v2 = signal[0] * signal_v2[0] + signal[1] * signal_v2[1]
        + signal[2] * signal_v2[2];
  if (dotproduct_v1 > dotproduct_v2) {
    // printf(“v1 is more coherent\n”);
    return 0;
  } else if (dotproduct_v1 == dotproduct_v2) {
    // printf(“Two even samples have the same importance level!\n″);
    return 2;
  } else {
  // printf(“v2 is more coherent\n”);
    return 1;
  }
}
```

The directional lifting is applied only to the first component of the displacement vector which essentially makes computing coherence using dot product redundant. Same coherence can be computed by comparing (e.g., just comparing) the values of first component of each vertex as follows:

```
computeCoherence(const T signal, const T signal_v1, const T signal_v2) {
  <del>
  auto dotproduct_v1 = signal[0] * signal_v1[0] + signal[1] * signal_v1[1] +
        signal[2] * signal_v1[2];
  auto dotproduct_v2 = signal[0] * signal_v2[0] + signal[1] * signal_v2[1] +
        signal[2] * signal_v2[2];
  </del>
  if (signal_v1[0] > signal_v2[0]) {
    // printf(“v1 is more coherent\n”);
    return 0;
  } else if (signal_v1[0] == signal_v2[0]) {
    // printf(“Two even samples have the same importance level!\n”);
    return 2;
  } else {
    // printf(“v2 is more coherent\n”);
    return 1;
  }
}
```

Checking the unlikely case of the dot product being equal in computing coherence will now be discussed. A problem with current implementations is that, in a coherence calculation, three conditions are tested. The likelihood of a dot product of neighboring vertices with the target vertex being equal is very low, making the check redundant. As a potential solution, the highly unlikely condition check can be removed from the computeCoherence process as follows:

```
computeCoherence(const T signal, const T signal_v1, const T signal_v2) {
  auto dotproduct_v1 = signal[0] * signal_v1[0] + signal[1] * signal_v1[1]
        + signal[2] * signal_v1[2];
  auto dotproduct_v2 = signal[0] * signal_v2[0] + signal[1] * signal_v2[1]
        + signal[2] * signal_v2[2];
  if (dotproduct_v1 > dotproduct_v2) {
    // printf(“v1 is more coherent\n”);
    return 0;
<del>
  } else if (dotproduct_v1 == dotproduct_v2) {
    // printf(“Two even samples have the same importance level!\n”);
    return 2;
  } else {
</del>
    // printf(“v2 is more coherent\n”);
  return 1;
  }
}
```

An example of this solution combined with the simplifications discussed above with respect to dot product coherence may be as follows:

```
computeCoherence(const T signal, const T signal_v1, const T signal_v2) {
  if (signal_v1[0] > signal_v2[0]) {
    // printf(“v1 is more coherent\n”);
    return 0;
  } else {
    // printf(“v2 is more coherent\n”);
    return 1;
  }
}
```

A simplification of a scale calculation will now be discussed. A problem with current implementations is that a scale is chosen based on a value ‘k’ which is selected based on the range the z-score falls into, making for a two-step calculation with multiple constants that are hard coded. A potential solution is that for directional lifting algorithm, V-DMC encoder 200 and V-DMC decoder 300 may be configured to determine the value k is based on Z_{score} as follows:

$$\begin{matrix}k = 0.5 if {Z}_{s c o r e} < 1 \\ = 0.75 if {Z}_{s c o r e} < 2 \\ = 0.95 otherwise\end{matrix}$$

Then, V-DMC encoder 200 and V-DMC decoder 300 may be configured to determine the scale as:

$${U}_{s c a l e} = {( k * 0.1 + 0.9 )}^{⋀} 2 - 1 for update$$

$${P}_{s c a l e} = {( k * 0.1 + 0.9 )}^{⋀} 1 - 1 for prediction$$

These two-step calculation can be combined as follows:

The value k is selected based on Z_{score} as follows:

$$\begin{matrix}k = 0.5 * 0. 1 + 0.9 = 0.95 if {Z}_{s c o r e} < 1 \\ = 0.75 * 0.1 + 0.9 = 0.9 \; 75 if {Z}_{s c o r e} < 2 \\ = 0.95 * 0.1 + 0.9 = 0.9 \; 95 otherwise\end{matrix}$$

Then, V-DMC encoder 200 and V-DMC decoder 300 may be configured to determine the scale as:

$${U}_{s c a l e} = {( k )}^{⋀} 2 - 1 for update$$

$${P}_{s c a l e} = {( k )}^{⋀} 1 - 1 for prediction$$

Division for z-score calculation will now be discussed. A problem with current implementations is that a division with standard deviation to calculate z-score is used which is essentially compared to choose the value ‘k’ making for an expensive operation which can be simplified. A potential solution is as follows:

$${Z}_{s c o r e} is computed as abs ( signal [ v ] - μ ) / σ$$

The value k is selected based on Z_{score} as follows:

$$\begin{matrix}k = 0.5 if {Z}_{s c o r e} < 1 \\ = 0.75 if {Z}_{s c o r e} < 2 \\ = 0.95 otherwise\end{matrix}$$

The division to calculate Z-score can be removed and the above-mentioned steps in directional lifting algorithm can be simplified as follows:

$${Z}_{n u m} is computed as abs ( signal [ v ] - μ )$$

The value k is selected based on Z_{score} as follows:

$$\begin{matrix}k = 0.5 if {Z}_{n u m} < σ \\ = 0.75 if {Z}_{n u m} < 2 * σ \\ = 0.95 Otherwise\end{matrix}$$

The following is code after combining all the simplifications:

```
template<class T1, class T2>
void
applyDirectionalWeights(std::vector<T1>& signal,
  int32_t v, int32_t v1, int32_t v2,
  const std::vector<double> dirScale,
```

| | |
|---|---|
| const T2 | predWeight, |
| const T2 | updateWeight1, |
| const T2 | updateWeight2, |
| double | scale1, |
| double | scale2, |
| double | scale3, |
| const bool | isPredStep, |
| const bool | isInverse) { |

```
  auto d1 = updateWeight1 * signal[v];
  auto d2 = updateWeight2 * signal[v];
  auto ps1 = predWeight * signal[v1];
  auto ps2 = predWeight * signal[v2];
  auto mean_global = dirScale[0];
  auto std_global = dirScale[1];
  if (isInverse) {
    auto signal_v_rec = isPredStep ? signal[v] : (signal[v] + predWeight * (signal[v1] +
signal[v2]));
    int8_t coherence = (signal[v1][0] > signal[v2][0]) ? 0 : 1;
    double z_score = std::abs(signal_v_rec[0] − mean_global);
    auto weight = (z_score < std_global) ? scale1 : (z_score < (2*std_global)) ? scale2 :
scale3;
    auto weight_normalized = pow((weight), (isPredStep == false ? 2 : 1)) − 1.;
    if (coherence <= 1) {
      if (isPredStep) {
        auto ps = coherence ? ps1 : ps2;
        signal[v] += weight_normalized * ps;
      }
      else {
        auto ps = coherence ? v1 : v2;
        auto d = ps == v1 ? d1 : d2;
        signal[ps] −= weight_normalized * d;
      }
    }
  }
```

Where, scale1, scale2 and scale3 are 0.95, 0.975 and 0.995 respectively. The scales can be either hard coded or signaled in the bitstream as explained in more detail below.

A patch-level directional lifting enable flag will now be discussed. A problem with current implementations is that if, at the Sequence Parameter Set (SPS) level, the transform type is none, then the directional lifting flag may be disabled, and when the transform type is overridden at the meshpatch level, then a directional lifting transform cannot be enabled. Also, if the subdivision process is overridden at the meshpatch level, for example, to mid/mid/loop, then the directional lifting transform cannot be disabled at the meshpatch level. Introducing functionality to enable the directional lifting transform at the meshpatch level provides a possible solution to the above-mentioned problem and may be more appropriate because directional lifting is applied at the patch level and is unique to each patch. This technique may be achieved by moving the syntax element asve_directional_lifting_present_flag as shown below. Throughout this disclosure, the delimiters <add> and </add> are used to show added text, and the delimiters <del> and </del> are used to show deleted text.

ASPS

| | Descriptor |
|---|---|
| asps_vdmc_extension( ) { | |
| asve_subdivision_iteration_count | u(3) |
| AspsSubdivisionCount = asve_subdivision_iteration_count | |
| if( AspsSubdivisionCount > 1 ) { | |
| asve_lod_adaptive_subdivision_flag | u(1) |
| } | |
| if( AspsSubdivisionCount > 0 ) { | |
| asve_edge_based_subdivision_flag | u(1) |
| } | |
| for( i=0; i < AspsSubdivisionCount ; i++) { | |
| if( asve_lod_adaptive_subdivision_flag == 1 \|\| i == 0 ) { | |
| asve_subdivision_method[ i ] | u(3) |
| } else { | |
| asve_subdivision_method[ i ] = asve_subdivision_method[ 0 ] | |
| } | |
| AspsSubdivisionMethod[ i ] = asve_subdivision_method[ i ] | |
| } | |
| if( asve_edge_based_subdivision_flag == 1 ) { | |
| asve_subdivision_min_edge_length | u(16) |
| AspsSubdivisionMinEdgeLength = asve_subdivision_min_edge_length | |
| } else { | |
| AspsSubdivisionMinEdgeLength = 0 | |
| } | |
| asve_1d_displacement_flag | u(1) |
| asve_interpolate_subdivided_normals_flag | u(1) |
| asve_displacement_reference_qp_minus49 | se(v) |
| asve_quantization_parameters_present_flag | u(1) |
| if( asve_quantization_parameters_present_flag ) { | |
| asve_inverse_quantization_offset_present_flag | u(1) |
| vdmc_quantization_parameters( 0, AspsSubdivisionCount, 0) | |
| } | |
| if( AspsSubdivisionCount != 0 ) { | |
| asve_transform_method | u(3) |
| Asps TransformMethod = asve_transform_method | |
| } | |
| asve_lifting_offset_present_flag | u(1) |
| <add>asve_directional_lifting_present_flag</add> | u(1) |
| if( asve_transform_method == LINEAR_LIFTING && AspsSubdivisionCount != 0 | |
| ) { | |
| <del>asve_directional_lifting_present_flag</del> | u(1) |
| vdmc_lifting_transform_parameters( 0, AspsSubdivisionCount ) | |
| } | |
| asve_attribute_information_present_flag | u(1) |
| if( asve_attribute_information_present_flag ) { | |
| asve_consistent_attribute_frame_flag | u(1) |
| if(!asve_consistent_attribute_frame_flag) { | |
| asve_attribute_frame_count | u(7) |
| } | |
| for(i=0; i< AspsAttributeNominalFrameCount; i++){ | |
| asve_attribute_frame_width[ i ] | ue(v) |
| asve_attribute_frame_height[ i ] | ue(v) |
| asve_attribute_subtexture_enabled_flag[ i ] | u(1) |
| } | |
| } | |
| asve_displacement_id_present_flag | u(1) |
| asve_lod_patches_enable_flag | u(1) |
| asve_packing_method | u(1) |
| if ( !asve_attribute_information_present_flag ) { | |
| asve_projection_texcoord_enable_flag | u(1) |
| if( asve_projection_texcoord_enable_flag ){ | |
| asve_projection_texcoord_mapping_attribute_index_present_flag | u(1) |
| if( asve_projection_texcoord_mapping_attribute_index_present_flag ) { | |
| asve_projection_texcoord_mapping_attribute_index | u(7) |
| } | |
| asve_projection_texcoord_output_bit_depth_minus1 | u(5) |
| asve_projection_texcoord_bbox_bias_enable_flag | u(1) |
| asve_projection_texcoord_upscale_factor_minus1 | u(40) |
| asve_projection_texcoord_log2_downscale_factor | u(6) |
| asve_projection_raw_textcoord_present_flag | u(1) |
| if( asve_projection_raw_textcoord_present_flag ) | |
| asve_projection_raw_textcoord_bitdepth_minus1 | u(v) |
| } | |
| } | |
| asve_vdmc_vui_parameters_present_flag | u(1) |
| if( asve_vdmc_vui_parameters_present_flag ) | |
| vdmc_vui_parameters( ) | |
| } | |

Meshpatch data unit syntax

| | Descriptor |
|---|---|
| meshpatch_data_unit( tileID, patchIdx ) { | |
| mdu_submesh_id[ tileID ][ patchIdx ] | ue(v) |
| if( ath_type == P_TILE \|\| ath_type == I_TILE ) { | |
| if( AspsDisplacementIdPresentFlag ) { | |
| mdu_displ_id[ tileID ][ patchIdx ] | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| mdu_parameters_override_flag[ tileID ][ patchIdx ] | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| if( asve_quantization_parameters_present_flag ) | |
| mdu_quantization_present_flag[ tileID ][ patchIdx ] | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag == 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivisionMinEdgeLength | |
| } | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for(j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ | se(v) |
| k ] | |
| mdu_inverse_quantization_offset_value_log2_prec2_delta[ tileID ][ patchIdx ][ i ][ j ][ | se(v) |
| k ] | |
| } | |
| } | |
| } | |
| } | |
| } | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ] == LINEAR_LIFTING ) { | |
| if( AspsLiftingOffsetPresentFlag ) { | |
| mdu_lifting_offset_present_flag [ tileID ][ patchIdx ] | u(1) |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| <add>mdu_directional_lifting_present_flag | u(1) |
| [ tileID ][ patchIdx ] </add> | |
| <add>if( mdu_directional_lifting_present_flag[ tileID ][ patchIdx ] ) {</add> | |
| for( i = 0; i < 2; i++ ) { | |
| mdu_directional_lifting_scale_num[ tileID ][ patchIdx ][ i ] | se(v) |
| } | |
| <add>}</add> | |
| } | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } | |
| } else { | |
| vertexInfoCount = 1 | |
| } | |
| for( i = 0; i < vertexInfoCount; i++ ) { | |
| mdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| if( ath_type == P_TILE_ATT \|\|ath_type == I_TILE_ATTR ) { | |
| i = TileIDToAtlasAttributeIdx[ tileID ] | |
| if( AspsAttributeSubtextureEnabledFlag[ i ] ){ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |

mdu_directional_lifting_present_flag[tileID][patchIdx] equal to 1 indicates that the directional lifting parameters are present for a meshpatch with index patchIdx, in the current atlas tile, with tile ID equal to tileID. mdu_directional_lifting_present_flag[tileID][patchIdx] equal to 0 indicates that the directional lifting parameters are not present. When not present, mdu_directional_lifting_present_flag[tileID][patchIdx] is inferred to be equal to 0.

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][j | se(v) |
| ][ k ] | |
| mmdu_inverse_quantization_offset_value_log2_prec2_delta[ tileID ][ patchIdx ][ i ][j | se(v) |
| ][ k ] | |
| } | |
| } | |
| } | |
| } | |
| } | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| <add> mmdu_directional_lifting_present_flag [ tileID ][ patchIdx ] | u(1) |
| </add> | |
| <add> if( mmdu_directional_lifting_present_flag[ tileID ][ patchIdx ] ) {</add> | |
| for( i = 0; i < 2; i++ ) { | |
| mmdu_directional_lifting_scale_num[ tileID ][ patchIdx ][ i ] | se(v) |
| } | |
| <add> }</add> | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_directional_lifting_present_flag[tileID][patchIdx] equal to 1 indicates that the directional lifting parameters are present for a meshpatch with index patchIdx, in the current with atlas tile, tile ID equal to tileID. mmdu_directional_lifting_present_flag[tileID][patchIdx] equal to 0 indicates that the directional lifting parameters are not present. When not present, mmdu_directional_lifting_present_flag[tileID][patchIdx] is inferred to be equal to 0.

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ] | se(v) |
| [k] | |
| imdu_inverse_quantization_offset_value_log2_prec2_delta[ tileID ][ patchIdx ][ i ][ j ] | se(v) |
| [k] | |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| <add> imdu_directional_lifting_present_flag [ tileID ][ patchIdx ] | u(1) |
| </add> | |
| <add> if( imdu_directional_lifting_present_flag[ tileID ][ patchIdx ] ) {</add> | |
| for( i = 0; i < 2; i++ ) { | |
| imdu_directional_lifting_scale_num[ tileID ][ patchIdx ][ i ] | se(v) |
| } | |
| <add> }</add> | |
| } | |
| if( InterPatchTransformMethod[ tileID ][ patchIdx ] == LINEAR_LIFTING && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_directional_lifting_present_flag[tileID][patchIdx] equal to 1 indicates that the directional lifting parameters are present for a meshpatch with index patchIdx, in the current atlas tile, with tile ID equal to tileID. imdu_directional_lifting_present_flag[tileID][patchIdx] equal to 0 indicates that the directional lifting parameters are not present. When not present, imdu_directional_lifting_present_flag[tileID][patchIdx] is inferred to be equal to 0.

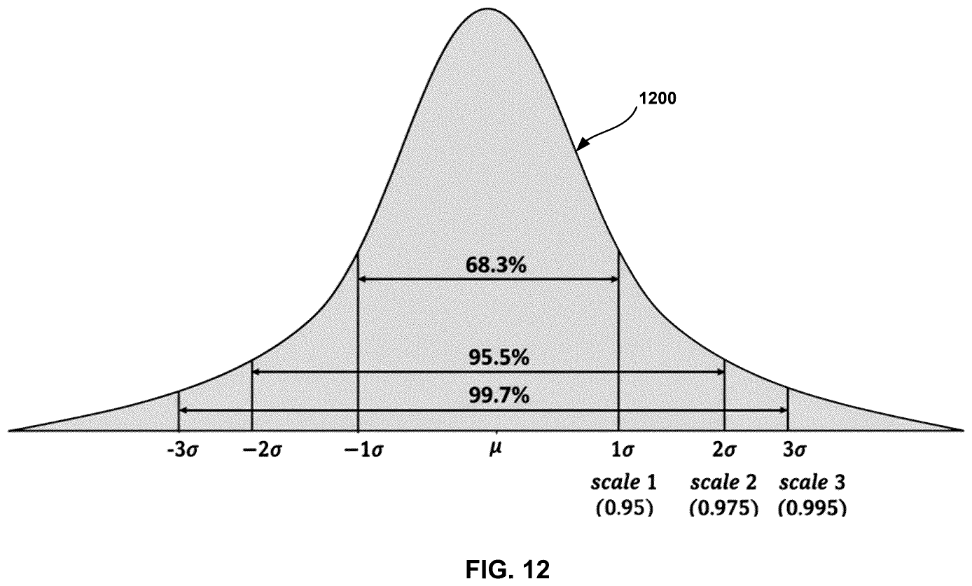

Signaling thresholds in directional lifting will now be discussed. A problem with current implementations is that the performance is sensitive to the three threshold ranges to calculate the value of ‘k’/scale but, the ranges are currently neither optimized nor signaled. Also, there is potentially too much flexibility to enable or disable directional lifting per LOD which introduces too many update weight cases for the lifting transform. With reference to the simplification described above with respect to the division for z-score calculation, a possible solution is that currently the three scales based on the range of z-score may be hard coded as scale1=0.95, scale2=0.975 and scale3=0.995 as shown in FIG. 12.

FIG. 12 is a conceptual diagram illustrating a normal distribution 1200 of signal values, such as wavelet coefficients, relative to a mean value μ and standard deviation intervals σ. FIG. 12 visualizes how the directional lifting algorithm selects specific scale factors—shown as scale 1 (0.95), scale 2 (0.975), and scale 3 (0.995)—based on the statistical deviation of a target vertex's value. Specifically, V-DMC encoder 200 and V-DMC decoder 300 may be configured to utilize these thresholds to categorize the “Z-score” or absolute deviation of a signal. If the deviation falls within one standard deviation (1σ), then V-DMC encoder 200 and V-DMC decoder 300 may be configured to apply the first scale, whereas deviations falling within two standard deviations (2σ) or three standard deviations (3σ) trigger the second or third scales, respectively. This selection process enables the directional lifting transform to adaptively weight the prediction and update steps based on the statistical likelihood of the signal value, thereby improving coding efficiency.

As the performance of the tool is sensitive to the scales, it may be useful to signal the scales, and an efficient way to signal the scales may be to determine a relation between the scales. The value for scale1 can be signaled as a one minus value. Then, scale2 can be deduced from scale 1, and scale3 can be deduced from scale2, so on and so forth or set to 1 shown in the steps as follows:

$$scale 1 = 1 - \frac{Δ scale}{1} ; for z - score < 1 σ$$

$$scale 2 = scale 1 + \frac{Δ scale}{2} ; for z - score < 2 σ$$

$$scale 3 = scale 2 + \frac{Δ scale}{3} ; for z - score < 3 σ or otherwise$$

$$Or ,$$

$$scale 3 = scale 2 + \frac{Δ scale}{2} ; for z - score < 3 σ or otherwise$$

Now, reduced signaling for Δscale may be signaled instead of three scale values. The value of Δscale can be signaled as base+10^{-exp} This Δscale value can be signaled as part of the lifting transform parameters and can be optimized. The number of update cases can be reduced by removing the flexibility to enable or disable the directional lifting transform as follows:

Lifting transform parameters syntax

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount ; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| vltp_adaptive_update_weight_flag[ ltpIndex ] | u(1) |
| vltp_valence_update_flag[ ltpIndex ] | u(1) |
| } | |
| if( vltp_adaptive_update_weight_flag[ ltpIndex ] == 1 \|\| i == 0) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| } else { | |
| UpdateWeight[ ltpIndex ][ i ] = UpdateWeight[ ltpIndex ][ 0 ] | |
| } | |
| } | |
| } | |
| vltp_adaptive_prediction_weight_flag[ ltpIndex ] | u(1) |
| if( vltp_adaptive_prediction_weight_flag[ ltpIndex ] ) { | |
| for( i=0 ; i < subdivisionCount; i++ ) { | |
| vltp_lifting_prediction_weight_numerator[ ltpIndex ][ i ] | ue(v) |
| vltp_lifting_prediction_weight_denominator_minus1[ ltpIndex ][ i ] | ue(v) |
| } | |
| } | |
| for( i=0 ; i < subdivisionCount; i++ ) { | |
| PredictionWeight[ ltpIndex ][ i ] = | |
| ( vltp_lifting_prediction_weight_numerator[ ltpIndex ][ i ] ) ÷ | |
| ( vltp_lifting_prediction_weight_denominator_minus1[ ltpIndex ][ i ] + 1 ) | |
| } | |
| if (asve_directional_lifting_present_flag) { | |
| <add>vltp_directional_lifting_scale_base[ ltpIndex ] </add> | ue(v) |
| <add>vltp_directional_lifting_scale_exp[ ltpIndex ] </add> | ue(v) |
| <del>for( i = 0; i < subdivisionCount; i++ ) {</del> | |
| <del> vltp_directional_lifting_lod_flag[ ltpIndex ][ i ] </del> | u(1) |
| <del> }</del> | |
| } | |
| } | |

vltp_directional_lifting_scale_base[ltpIndex] indicates the value of base of the scale used in directional lifting to adapt prediction and update weights in the lifting transform. ltpIndex is the index of the lifting transform parameter set.
vltp_directional_lifting_scale_exp[ltpIndex] indicates the value of exponent in power of 10 used to represent scale value used in directional lifting to adapt prediction and update weights in the lifting transform. ltpIndex is the index of the lifting transform parameter set.

With this scale deduction process, the inverse directional lifting algorithm with all the simplification may be implemented as follows:

```
template<class T1, class T2>
void
applyDirectionalWeights(std::vector<T1>& signal,
  int32_t v, int32_t v1, int32_t v2,
  const std::vector<double> dirScale,
```

| | |
|---|---|
| const T2 | predWeight, |
| const T2 | updateWeight1, |
| const T2 | updateWeight2, |
| double | scale, |
| const bool | isPredStep, |
| const bool | isInverse) { |

```
  auto d1 = updateWeight1 * signal[v];
  auto d2 = updateWeight2 * signal[v];
  auto ps1 = predWeight * signal[v1];
  auto ps2 = predWeight * signal[v2];
<add>
  double scale1 = 1− scale;
  double scale2 = scale1 + scale/2;
  double scale3 = scale2 + scale/3;
</add>
  auto mean_global = dirScale[0];
  auto std_global = dirScale[1];
  if (isInverse) {
    auto signal_v_rec = isPredStep ? signal[v] : (signal[v] + predWeight * (signal[v1] +
signal[v2]));
    int8_t coherence = (signal[v1][0] > signal[v2][0]) ? 0 : 1;
    double z_score = std::abs(signal_v_rec[0] − mean_global);
    auto weight = (z_score < std_global) ? scale1 : (z_score < (2*std_global)) ? scale2 :
scale3;
    auto weight_normalized = pow((weight), (isPredStep == false ? 2 : 1)) − 1.;
    if (coherence <= 1) {
      if (isPredStep) {
        auto ps = coherence ? ps1 : ps2;
        signal[v] += weight_normalized * ps;
      }
      else {
        autops = coherence ? v1 : v2;
        auto d = ps == v1 ? d1 : d2;
        signal[ps] −= weight_normalized * d;
      }
    }
  }
Or
template<class T1, class T2>
void
applyDirectionalWeights(std::vector<T1>& signal,
  int32_t v, int32_t v1, int32_t v2,
  const std::vector<double> dirScale,
```

| | |
|---|---|
| const T2 | predWeight, |
| const T2 | updateWeight1, |
| const T2 | updateWeight2, |
| double | scale, |
| const bool | isPredStep, |
| const bool | isInverse) { |

```
  auto d1 = updateWeight1 * signal[v];
  auto d2 = updateWeight2 * signal[v];
  auto ps1 = predWeight * signal[v1];
  auto ps2 = predWeight * signal[v2];
<add>
  double scale1 = 1− scale;
  double scale2 = scale1 + scale/2;
  double scale3 = 1;
</add>
  auto mean_global = dirScale[0];
  auto std_global = dirScale[1];
  if (isInverse) {
    auto signal_v_rec = isPredStep ? signal[v] : (signal[v] + predWeight * (signal[v1] +
signal[v2]));
    int8_t coherence = (signal[v1][0] > signal[v2][0]) ? 0 : 1;
    double z_score = std::abs(signal_v_rec[0] − mean_global);
    auto weight = (z_score < std_global) ? scale1 : (z_score < (2*std_global)) ? scale2 :
scale3;
    auto weight_normalized = pow((weight), (isPredStep == false ? 2 : 1)) − 1.;
    if (coherence <= 1) {
      if (isPredStep) {
        auto ps = coherence ? ps1 : ps2;
        signal[v] += weight_normalized * ps;
      }
      else {
        auto ps = coherence ? v1 : v2;
        auto d = ps == v1 ? d1 : d2;
        signal[ps] −= weight_normalized * d;
      }
    }
  }
Or
template<class T1, class T2>
void
applyDirectionalWeights(std::vector<T1>& signal,
      int32_t v, int32_t v1, int32_t v2,
      const std::vector<double> dirScale,
```

| | |
|---|---|
| const T2 | predWeight, |
| const T2 | updateWeight1, |
| const T2 | updateWeight2, |
| double | scale, |
| const bool | isPredStep, |
| const bool | isInverse) { |

```
      auto d1 = updateWeight1 * signal[v];
      auto d2 = updateWeight2 * signal[v];
      auto ps1 = predWeight * signal[v1];
      auto ps2 = predWeight * signal[v2];
<add>
      double scale1 = 1− scale;
      double scale2 = scale1 + scale/2;
      double scale3 = scale2 + scale/2;
</add>
      auto mean_global = dirScale[0];
      auto std_global = dirScale[1];
      if (isInverse) {
      auto signal_v_rec = isPredStep ? signal[v] : (signal[v] + predWeight * (signal[v1] +
signal[v2]));
        int8_t coherence = (signal[v1][0] > signal[v2][0]) ? 0 : 1;
        double z_score = std::abs(signal_v_rec[0] − mean_global);
        auto weight = (z_score < std_global) ? scale1 : (z_score < (2*std_global)) ? scale2
: scale3;
        auto weight_normalized = pow((weight), (isPredStep == false ? 2 : 1)) − 1.;
        if (coherence <= 1) {
          if (isPredStep) {
            auto ps = coherence ? ps1 : ps2;
            signal[v] += weight_normalized * ps;
          }
          else {
            auto ps = coherence ? v1 : v2;
            auto d = ps == v1 ? d1 : d2;
            signal[ps] −= weight_normalized * d;
          }
        }
      }
```

Another way to signal the three threshold cut-offs is to signal them independently with the same precision that can be signaled as follows:

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount ; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| vltp_adaptive_update_weight_flag[ ltpIndex ] | u(1) |
| vltp_valence_update_flag[ ltpIndex ] | u(1) |
| } | |
| if( vltp_adaptive_update_weight_flag[ ltpIndex ] == 1 \|\| i == 0) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| } else { | |
| UpdateWeight[ ltpIndex ][ i ] = UpdateWeight[ ltpIndex ][ 0 ] | |
| } | |
| } | |
| } | |
| vltp_adaptive_prediction_weight_flag[ ltpIndex ] | u(1) |
| if( vltp_adaptive_prediction_weight_flag[ ltpIndex ] ) { | |
| for( i=0 ; i < subdivisionCount; i++ ) { | |
| vltp_lifting_prediction_weight_numerator[ ltpIndex ][ i ] | ue(v) |
| vltp_lifting_prediction_weight_denominator_minus1[ ltpIndex ][ i ] | ue(v) |
| } | |
| } | |
| for( i=0 ; i < subdivisionCount; i++ ) { | |
| PredictionWeight[ ltpIndex ][ i ] = | |
| ( vltp_lifting_prediction_weight_numerator[ ltpIndex ][ i ] ) ÷ | |
| ( vltp_lifting_prediction_weight_denominator_minus1[ ltpIndex ][ i ] + 1 ) | |
| } | |
| if (asve_directional_lifting_present_flag) { | |
| vltp_directional_lifting_scale1[ ltpIndex ] | ue(v) |
| vltp_directional_lifting_scale2[ ltpIndex ] | ue(v) |
| vltp_directional_lifting_scale3[ ltpIndex ] | ue(v) |
| vltp_directional_lifting_scale_deno_minus1[ ltpIndex ] | ue(v) |
| } | |
| } | |

vltp_directional_lifting_scale1[ltpIndex] indicates the value of first threshold to choose a scale used in directional lifting to adapt prediction and update weights in the lifting transform. ltpIndex is the index of the lifting transform parameter set.
vltp_directional_lifting_scale2[ltpIndex] indicates the value of second threshold to choose a scale used in directional lifting to adapt prediction and update weights in the lifting transform. ltpIndex is the index of the lifting transform parameter set.
vltp_directional_lifting_scale3[ltpIndex] indicates the value of third threshold to choose a scale used in directional lifting to adapt prediction and update weights in the lifting transform. ltpIndex is the index of the lifting transform parameter set.
vltp_directional_lifting_scale_deno minus1[ltpIndex] indicates the precision used to signal all the thresholds used in directional lifting to adapt prediction and update weights in the lifting transform. ltpIndex is the index of the lifting transform parameter set.

Another way to signal three scales that offers the flexibility of the above solution but with a minimal metadata increase is as follows:

| | Descriptor |
|---|---|
| vdmc_lifting_transform_parameters( ltpIndex, subdivisionCount ){ | |
| vltp_skip_update_flag[ ltpIndex ] | u(1) |
| for( i = 0 ; i < subdivisionCount ; i++ ) { | |
| if( vltp_skip_update_flag[ ltpIndex ] ) { | |
| UpdateWeight[ ltpIndex ][ i ] = 0 | |
| } else { | |
| if( i == 0 ) { | |
| vltp_adaptive_update_weight_flag[ ltpIndex ] | u(1) |
| vltp_valence_update_flag[ ltpIndex ] | u(1) |
| } | |
| if( vltp_adaptive_update_weight_flag[ ltpIndex ] == 1 \|\| i == 0) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| } else { | |
| UpdateWeight[ ltpIndex ][ i ] = UpdateWeight[ ltpIndex ][ 0 ] | |
| } | |
| } | |
| } | |
| vltp_adaptive_prediction_weight_flag[ ltpIndex ] | u(1) |
| if( vltp_adaptive_prediction_weight_flag[ ltpIndex ] ) { | |
| for( i=0 ; i < subdivisionCount; i++ ) { | |
| vltp_lifting_prediction_weight_numerator[ ltpIndex ][ i ] | ue(v) |
| vltp_lifting_prediction_weight_denominator_minus1[ ltpIndex ][ i ] | ue(v) |
| } | |
| } | |
| for( i=0 ; i < subdivisionCount; i++ ) { | |
| PredictionWeight[ ltpIndex ][ i ] = | |
| ( vltp_lifting_prediction_weight_numerator[ ltpIndex ][ i ] ) ÷ | |
| ( vltp_lifting_prediction_weight_denominator_minus1[ ltpIndex ][ i ] + 1 ) | |
| } | |
| <add> | |
| if (asve_directional_lifting_present_flag) { | |
| vltp_directional_lifting_scale1[ ltpIndex ] | ue(v) |
| vltp_directional_lifting_delta_scale2[ ltpIndex ] | ue(v) |
| vltp_directional_lifting_delta_scale3[ ltpIndex ] | ue(v) |
| vltp_directional_lifting_scale_deno_minus1[ ltpIndex ] | ue(v) |
| } | |
| </add> | |
| } | |

vltp_directional_lifting_scale1[ltpIndex] indicates the value of first threshold to choose as the first scale value used in directional lifting to adapt prediction and update weights in the lifting transform. ltpIndex is the index of the lifting transform parameter set.
vltp_directional_lifting_delta_scale2[ltpIndex] indicates the difference between first and second threshold to compute the second scale used in directional lifting to adapt prediction and update weights in the lifting transform. ltpIndex is the index of the lifting transform parameter set.
vltp_directional_lifting_delta_scale3[ltpIndex] indicates the difference between second and third threshold to compute the third scale used in directional lifting to adapt prediction and update weights in the lifting transform. ltpIndex is the index of the lifting transform parameter set.
vltp_directional_lifting_scale_deno minus1[ltpIndex] plus 1 indicates the precision used to signal all the thresholds used in directional lifting to adapt prediction and update weights in the lifting transform. ltpIndex is the index of the lifting transform parameter set.

And the three scales can be computed as follows:

$$Scale 1 = vltp\_directional \_lifting \_scale1 [ ltpIndex ] / ( vltp\_directional \_lifting \_scale \_deno \_minus1 [ ItpIndex ] + 1 )$$

$$Scale 2 = Scale 1 + ( vltp\_directional \_lifting \_delta \_scale2 [ ItpIndex ] / ( vltp\_directional \_lifting \_scale \_deno \_minus1 [ ItpIndex ] + 1 ) )$$

$$Scale 3 = Scale 2 + ( vltp\_directional \_lifting \_delta \_scale3 [ ltpIndex ] / ( vltp\_directional \_lifting \_scale \_deno \_minus1 [ ltpIndex ] + 1 ) )$$

The above equations illustrate how V-DMC decoder 300 may reconstruct the three scale values used in the directional lifting transform. The first scale (Scale1) is calculated by dividing a signaled numerator by a common denominator. The second and third scales (Scale2 and Scale3) are then calculated using a delta-coding approach to improve signaling efficiency. Specifically, Scale2 is derived by adding a first delta value to Scale1, and Scale3 is derived by adding a second delta value to Scale2. All three calculations utilize the same denominator (derived from the syntax element vltp_directional_lifting_scale_deno_minus1 plus 1) to establish the precision of the values.

Removing for loop and sending two directional lifting parameters will now be discussed. A problem with current implementations is that directional lifting scale parameters are two but sent as one parameter with index of 2 in meshpatch, inter meshpatch and merge meshpatch. A potential solution is to remove for loop and send two independent parameter for mean and standard deviation values.

Meshpatch data unit syntax

| | Descriptor |
|---|---|
| meshpatch_data_unit( tileID, patchIdx ) { | |
| mdu_submesh_id[ tileID ][ patchIdx ] | ue(v) |
| if( ath_type == P_TILE \|\| ath_type == I_TILE ) { | |
| if( AspsDisplacementIdPresentFlag ) { | |
| mdu_displ_id[ tileID ][ patchIdx ] | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| mdu_parameters_override_flag[ tileID ][ patchIdx ] | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| if( asve_quantization_parameters_present_flag ) | |
| mdu_quantization_present_flag[ tileID ][ patchIdx ] | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag == 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivisionMinEdgeLength | |
| } | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ | se(v) |
| k ] | |
| mdu_inverse_quantization_offset_value_log2_prec2_delta[ tileID ][ patchIdx ][ i ][ j ][ | se(v) |
| k ] | |
| } | |
| } | |
| } | |
| } | |
| } | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ]== LINEAR_LIFTING ) { | |
| if( AspsLiftingOffsetPresentFlag ) { | |
| mdu_lifting_offset_present_flag [ tileID ][ patchIdx ] | u(1) |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| <del>for( i = 0; i < 2; i++ ) {</del> | |
| <add>mdu_directional_lifting_mean_num[ tileID ][ patchIdx ] | se(v) |
| </add> | |
| <del> | ue(v) |
| mdu_directional_lifting_scale_num[ tileID ][ patchIdx ][ i ] | |
| </del> | |
| <add> | |
| mdu_directional_lifting_std_num[ tileID ][ patchIdx ] | |
| <add> | |
| <del>}</del> | |
| } | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++ ) { | |
| mdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| if( ath_type == P_TILE_ATT \|\|ath_type == I_TILE_ATTR ) { | |
| i = TileIDToAtlasAttributeIdx[ tileID ] | |
| if( AspsAttributeSubtextureEnabledFlag[ i ] ){ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |

mdu_directional_lifting_mean_num[tileID][patchIdx] indicates the numerator of the mean used to calculate z-score in the directional lifting, signalled for submesh with submesh ID mdu_submesh_id[tileID][patchIdx].
mdu_directional_lifting_std_num[tileID][patchIdx] indicates the numerator of the standard deviation used to calculate z-score in the directional lifting, signalled for submesh with submesh ID mdu_submesh_id[tileID][patchIdx].

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][ j | se(v) |
| ][ k ] | |
| mmdu_inverse_quantization_offset_value_log2_prec2_delta[ tileID ][ patchIdx ][ i ][ j | se(v) |
| ][ k ] | |
| } | |
| } | |
| } | |
| } | |
| } | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| <del> | |
| for( i = 0; i < 2; i++ ) {</del> | |
| <add> | se(v) |
| mmdu_directional_lifting_mean_num[ tileID ][ patchIdx ] | |
| </add> | |
| <del> | ue(v) |
| mmdu_directional_lifting_scale_num[ tileID ][ patchIdx ][ i ] | |
| </del> | |
| <add> | |
| mmdu_directional_lifting_std_num[ tileID ][ patchIdx ] | |
| </add> | |
| <del> | |
| }</del> | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_directional_lifting_mean_num[tileID][patchIdx] indicates the numerator of the mean used to calculate z-score in the directional lifting, signalled for submesh with submesh ID mdu_submesh_id[tileID][patchIdx].
mmdu_directional_lifting_std_num[tileID][patchIdx] indicates the numerator of the standard deviation used to calculate z-score in the directional lifting, signalled for submesh with submesh ID mdu_submesh_id[tileID][patchIdx].

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ] | se(v) |
| [ k ] | |
| imdu_inverse_quantization_offset_value_log2_prec2_delta[ tileID ][ patchIdx ][ i ][ j ] | se(v) |
| [ k ] | |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| <del> | |
| for( i = 0; i < 2; i++ ) {</del> | |
| <add> | se(v) |
| imdu_directional_lifting_mean_num[ tileID ][ patchIdx ] | |
| </add> | |
| <del> | ue(v) |
| imdu_directional_lifting_scale_num[ tileID ][ patchIdx ][ i ] | |
| </del> | |
| <add> | |
| imdu_directional_lifting_std_num[ tileID ][ patchIdx ] | |
| </add> | |
| <del> | |
| }</del> | |
| } | |
| if( InterPatchTransformMethod[ tileID ][ patchIdx ] == LINEAR_LIFTING && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_directional_lifting_mean_num[tileID][patchIdx] indicates the numerator of the mean used to calculate z-score in the directional lifting, signalled for submesh with submesh ID mdu_submesh_id[tileID][patchIdx].
imdu_directional_lifting_std_num[tileID][patchIdx] indicates the numerator of the standard deviation used to calculate z-score in the directional lifting, signalled for submesh with submesh ID mdu_submesh_id[tileID][patchIdx].

Signaling the denominator in directional lifting will now be discussed. A problem with current implementations is that the directional lifting parameters are sent as fractional values but only numerator with a precision of 2 is sent, and a decoder uses a fixed value of 100 to calculate the scale. A possible solution is to signal the denominator with optimum precision for completeness.

Meshpatch data unit syntax

| | Descriptor |
|---|---|
| meshpatch_data_unit( tileID, patchIdx ) { | |
| mdu_submesh_id[ tileID ][ patchIdx ] | ue(v) |
| if( ath_type == P_TILE \|\| ath_type == I_TILE ) { | |
| if( AspsDisplacementldPresentFlag ) { | |
| mdu_displ_id[ tileID ][ patchIdx ] | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| mdu_parameters_override_flag[ tileID ][ patchIdx ] | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| if( asve_quantization_parameters_present_flag ) | |
| mdu_quantization_present_flag[ tileID ][ patchIdx ] | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag == 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivisionMinEdgeLength | |
| } | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ | se(v) |
| k ] | |
| mdu_inverse_quantization_offset_value_log2_prec2_delta[ tileID ][ patchIdx ][ i ][ j ][ | se(v) |
| k ] | |
| } | |
| } | |
| } | |
| } | |
| } | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ]== LINEAR_LIFTING ) { | |
| if( AspsLiftingOffsetPresentFlag ) { | |
| mdu_lifting_offset_present_flag [ tileID ][ patchIdx ] | u(1) |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| for( i = 0; i < 2; i++ ) { | |
| mdu_directional_lifting_scale_num[ tileID ][ patchIdx ][ i ] | se(v) |
| <add> | ue(v) |
| mdu_directional_lifting_scale_deno_minus1 [tileID ][ patchIdx ][ i ] | |
| </add> | |
| } | |
| } | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++ ) { | |
| mdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| if( ath_type == P_TILE_ATT \|\|ath_type == I_TILE_ATTR ) { | |
| i = TileIDToAtlasAttributeIdx[ tileID ] | |
| if( AspsAttributeSubtextureEnabledFlag[ i ] ){ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |

mdu_directional_lifting_scale_deno_minus1[tileID][patchIdx][i] plus 1 indicates the denominator of the directional lifting scale used to adapt prediction and update weights in the lifting transform for the scale value signalled with index i for submesh with submesh ID mdu_submesh_id[tileID][patchIdx].

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][ j | se(v) |
| ][ k ] | |
| mmdu_inverse_quantization_offset_value_log2_prec2_delta[ tileID ][ patchIdx ][ i ][ j | se(v) |
| ][ k ] | |
| } | |
| } | |
| } | |
| } | |
| } | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| for( i = 0; i < 2; i++ ) { | |
| mmdu_directional_lifting_scale_num[ tileID ][ patchIdx ][ i ] | se(v) |
| <add> | ue(v) |
| mmdu_directional_lifting_scale_deno_minus1[ tileID ][ patchIdx ][ i ] | |
| </add> | |
| } | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_directional_lifting_scale_deno_minus1[tileID][patchIdx][i] plus 1 indicates the denominator of the directional lifting scale used to adapt prediction and update weights in the lifting transform for the scale value signalled with index i for submesh with submesh ID mdu_submesh_id[tileID][patchIdx].

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ] | se(v) |
| [ k ] | |
| imdu_inverse_quantization_offset_value_log2_prec2_delta[ tileID ][ patchIdx ][ i ][ j ] | se(v) |
| [ k ] | |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| for( i = 0; i < 2; i++ ) { | |
| imdu_directional_lifting_scale_num[ tileID ][ patchIdx ][ i ] | se(v) |
| <add> | ue(v) |
| imdu_directional_lifting_scale_deno_minus1[ tileID ][ patchIdx ][ i ] | |
| </add> | |
| } | |
| } | |
| if( InterPatchTransformMethod[ tileID ][ patchIdx ] == LINEAR_LIFTING && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_directional_lifting_scale_deno_minus1[tileID][patchIdx][i] plus 1 indicates the denominator of the directional lifting scale used to adapt prediction and update weights in the lifting transform for the scale value signalled with index i for submesh with submesh ID mdu_submesh_id[tileID][patchIdx].

Delta coding of directional lifting parameters will now be discussed. A problem with current implementations is that the directional lifting parameters are not delta coded for merge and inter meshpatches.

A possible solution is as follows:

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatch SubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][ j ][ k | se(v) |
| ] | |
| mmdu_inverse_quantization_offset_value_log2_prec2_delta[ tileID ][ patchIdx ][ i ][ j ][ k | se(v) |
| ] | |
| } | |
| } | |
| } | |
| } | |
| } | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| for( i = 0; i < 2; i++ ) { | |
| <del> | se(v) |
| mmdu_directional_lifting_ scale_num[ tileID ][ patchIdx ][ i ] | |
| </del> | |
| <add> | |
| mmdu_directional_lifting_delta_scale_num[ tileID ][ patchIdx ][ i ] | |
| </add> | |
| } | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_directional_lifting_delta_scale_num[tileID][patchIdx][i] specifies the difference of the numerator of the directional lifting scale used to adapt prediction and update weights in the lifting transform for the scale value signalled with index i in patch with a meshpatch with index patchIdx, in the current atlas tile, with tile ID equal to tileID.

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ][ k ] | se(v) |
| imdu_inverse_quantization_offset_value_log2_prec2_delta[ tileID ][ patchIdx ][ i ][ j ][ k ] | se(v) |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| for( i = 0; i < 2; i++ ) { | |
| <del> | se(v) |
| imdu_directional_lifting_ scale_num[ tileID ][ patchIdx ][ i ] | |
| </del> | |
| <add> | |
| imdu_directional_lifting_delta_scale_num[ tileID ][ patchIdx ][ i ] | |
| </add> | |
| } | |
| } | |
| if( InterPatchTransformMethod[ tileID ][ patchIdx ] == LINEAR_LIFTING && | |
| ( imdu_transform_parameters_present_flag[ tileID ][ patchIdx ] ∥ | |
| imdu_subdivision_iteration_count_present_flag[ tileID ][ patchIdx ] ∥ | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_directional_lifting_delta_scale_num[tileID][patchIdx][i] specifies the difference of the numerator of the directional lifting scale used to adapt prediction and update weights in the lifting transform for the scale value signalled with index i in patch with a meshpatch with index patchIdx, in the current atlas tile, with tile ID equal to tileID.

Reusing the mean from lifting offset for directional lifting will now be discussed. A problem with current implementations is that the lifting offset tool and directional lifting transform signals a mean of the same signal but signals them separately causing repetitive signaling. A possible solution is that the mean deduced and signaled for the lifting offset may be used in directional lifting and repetitive signaling of mean as directional lifting parameter may be removed as follows:

Meshpatch data unit syntax

| | Descriptor |
|---|---|
| meshpatch_data_unit( tileID, patchIdx ) { | |
| mdu_submesh_id[ tileID ][ patchIdx ] | ue(v) |
| if( ath_type == P_TILE \|\| ath_type == \|_TILE ) { | |
| if( AspsDisplacementIdPresentFlag ) { | |
| mdu_displ_id[ tileID ][ patchIdx ] | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| mdu_parameters_override_flag[ tileID ][ patchIdx ] | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| if( asve_quantization_parameters_present_flag ) | |
| mdu_quantization_present_flag[ tileID ][ patchIdx ] | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag == 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivisionMinEdgeLength | |
| } | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ | se(v) |
| k ] | |
| mdu_inverse_quantization_offset_value_log2_prec2_delta[ tileID ][ patchIdx ][ i ][ j ][ | se(v) |
| k ] | |
| } | |
| } | |
| } | |
| } | |
| } | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ]== LINEAR_LIFTING ) { | |
| if( AspsLiftingOffsetPresentFlag <add>\|\| | |
| AspsDirectionalLiftingPresentFlag </add> ) { | |
| mdu_lifting_offset_present_flag [ tileID ][ patchIdx ] | u(1) |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| <add> mdu_directional_lifting_std_num[ tileID ][ patchIdx ][ i ] | se(v) |
| </add> | |
| <del>for( i = 0; i < 2; i++ ) {</del> | |
| <del> | se(v) |
| mdu_directional_lifting_scale_num[ tileID ][ patchIdx ][ i ] | |
| </del> | |
| <del>}</del> | |
| } | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++ ) { | |
| mdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| if( ath_type == P_TILE_ATT \|\|ath_type == \|_TILE_ATTR ) { | |
| i = TileIDToAtlasAttributeIdx[ tileID ] | |
| if( AspsAttributeSubtextureEnabledFlag[ i ] }{ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][ j | se(v) |
| ][ k ] | |
| mmdu_inverse_quantization_offset_value_log2_prec2_delta[ tileID ][ patchIdx ][ i ][ j | se(v) |
| ][ k ] | |
| } | |
| } | |
| } | |
| } | |
| } | |
| if( AspsLiftingOffsetPresentFlag<add>\|\| AspsDirectionalLiftingPresentFlag | |
| </add> ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| <add> | se(v) |
| mmdu_directional_lifting_std_num[ tileID ][ patchIdx ][ i ] | |
| </add> | |
| <del> | |
| for( i = 0; i < 2; i++) { | |
| mmdu_directional_lifting_scale_num[ tileID ][ patchIdx ][ i ] | se(v) |
| } | |
| </del> | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ] | se(v) |
| [ k ] | |
| imdu_inverse_quantization_offset_value_log2_prec2_delta[ tileID ][ patchIdx ][ i ][ j ] | se(v) |
| [ k ] | |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag <add>\|\| | |
| AspsDirectionalLiftingPresentFlag </add> ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| <add> imdu_directional_lifting_std_num[ tileID ][ patchIdx ][ i ] | se(v) |
| </add> | |
| <del> | |
| for( i = 0; i < 2; i++ ) { | |
| imdu_directional_lifting_scale_num[ tileID ][ patchIdx ][ i ] | se(v) |
| } | |
| </del> | |
| } | |
| if( InterPatchTransformMethod[ tileID ][ patchIdx ] == LINEAR_LIFTING && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

A combination of the solutions discussed above for the patch level directional lifting enable flag,_signaling thresholds in directional lifting,_removing for loop and sending two directional lifting parameters, signaling the denominator in directional lifting, and delta coding of directional lifting parameters is as follows:

Meshpatch data unit syntax

| | Descriptor |
|---|---|
| meshpatch_data_unit( tileID, patchIdx ) { | |
| mdu_submesh_id[ tileID ][ patchIdx ] | ue(v) |
| if( ath_type == P_TILE \|\| ath_type == \|_TILE ) { | |
| if( AspsDisplacementIdPresentFlag ) { | |
| mdu_displ_id[ tileID ][ patchIdx ] | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| mdu_parameters_override_flag[ tileID ][ patchIdx ] | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| if( asve_quantization_parameters_present_flag ) | |
| mdu_quantization_present_flag[ tileID ][ patchIdx ] | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag == 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivision MinEdgeLength | |
| } | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for(j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ | se(v) |
| k ] | |
| mdu_inverse_quantization_offset_value_log2_prec2_delta[ tileID ][ patchIdx ][ i ][ j ][ | se(v) |
| k ] | |
| } | |
| } | |
| } | |
| } | |
| } | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ] == LINEAR_LIFTING ) { | |
| if( AspsLiftingOffsetPresentFlag ) { | |
| mdu_lifting_offset_present_flag [ tileID ][ patchIdx ] | u(1) |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| <add> | u(1) |
| mdu_directional_lifting_present_flag [ tileID ][ patchIdx ] | |
| </add> | |
| <add> | |
| if( mdu_directional_lifting_present_flag[ tileID ][ patchIdx ] ) { | |
| </add> | |
| <del>for( i = 0; i < 2; i++ ) {</del> | |
| <add> | se(v) |
| mdu_directional_lifting_mean_num[ tileID ][ patchIdx ] | |
| <add> | |
| <add> | ue(v) |
| mdu_directional_lifting_mean_deno_minus1[ tileID ][ patchIdx ] | |
| </add> | |
| <del> | ue(v) |
| mdu_directional_lifting_std_num[ tileID ][ patchIdx ] | |
| </del> | |
| <add> | |
| mdu_directional_lifting_std_num[ tileID ][ patchIdx ] | |
| </add> | |
| <add> | ue(v) |
| mdu_directional_lifting_std_deno_minus1[ tileID ][ patchIdx ] | |
| <add> | |
| <del>}</del> | |
| <add>}</add> | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++ ) { | |
| vmdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx] ) | |
| texture_projection_information( tileID, patchIdx ) | |
| } | |
| if( ath_type == P_TILE_ATT \|\| ath_type == \|_TILE_ATTR ) { | |
| i = TileIDToAtlasAttributeIdx[ tileID ] | |
| if( AspsAttributeSubtextureEnabledFlag[ i ] ){ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |

mdu_directional_lifting_present_flag[tileID][patchIdx] equal to 1 indicates that the directional lifting parameters are present for a meshpatch with index patchIdx, in the current atlas tile, with tile ID equal to tileID. mdu_directional_lifting_present_flag[tileID][patchIdx] equal to 0 indicates that the directional lifting parameters are not present. When not present, mdu_directional_lifting_present_flag[tileID][patchIdx] is inferred to be equal to 0.
mdu_directional_lifting_mean_num[tileID][patchIdx] indicates the numerator of the mean used to calculate z-score in the directional lifting, signalled with index i for submesh with submesh ID mdu_submesh_id[tileID][patchIdx].
mdu_directional_lifting_mean_deno_minus1[tileID][patchIdx] plus 1 indicates the denominator of mean used to calculate z-score in the directional lifting, signalled with index i for submesh with submesh ID mdu_submesh_id[tileID][patchIdx].
mdu_directional_lifting_std_num[tileID][patchIdx] indicates the numerator of the standard deviation used to calculate z-score in the directional lifting, signalled for submesh with submesh ID mdu_submesh_id[tileID][patchIdx].
mdu_directional_lifting_std_deno_minus1[tileID][patchIdx] plus 1 indicates the denominator of the standard deviation used to calculate z-score in the directional lifting, signalled for submesh with submesh ID mdu_submesh_id[tileID][patchIdx].

Merge meshpatch data unit syntax

| | Descriptor |
|---|---|
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] == 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCount | |
| } | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for(j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] | u(1) |
| mmdu_inverse_quantization_offset_value_log2_prec1_delta[ tileID ][ patchIdx ][ i ][ j | se(v) |
| ][k] | |
| mmdu_inverse_quantization_offset_value_log2_prec2_delta[ tileID ][ patchIdx ][ i ][ j | se(v) |
| ][k] | |
| } | |
| } | |
| } | |
| } | |
| } | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| <add> mmdu_directional_lifting_present_flag | u(1) |
| [ tileID ][ patchIdx ]</add> | |
| <add> | |
| if( mmdu_directional_lifting_present_flag[ tileID ][ patchIdx ] ) { | |
| </add> | |
| <del> for( i = 0; i < 2; i++ ) {</del> | |
| <add> | se(v) |
| mmdu_directional_lifting_delta_mean_num[ tileID ][ patchIdx ] | |
| </add> | |
| <add> | se(v) |
| mmdu_directional_lifting_delta_mean_deno[ tileID ][ patchIdx ] | |
| </add> | |
| <del> | se(v) |
| mmdu_directional_lifting_scale_num[ tileID ][ patchIdx ][ i ] | |
| </del> | |
| <add> | |
| mmdu_directional_lifting_delta_std_num[ tileID ][ patchIdx ] | |
| </add> | |
| <add> | se(v) |
| mmdu_directional_lifting_delta_std_deno[ tileID ][ patchIdx ] | |
| </add> | |
| <del> }</del> | |
| <add> }</add> | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_directional_lifting_present_flag[tileID][patchIdx] equal to 1 indicates that the directional lifting parameters are present for a meshpatch with index patchIdx, in the current atlas tile, with tile ID equal to tileID. imdu_directional_lifting_present_flag[tileID][patchIdx] equal to 0 indicates that the directional lifting parameters are not present. When not present, imdu_directional_lifting_present_flag[tileID][patchIdx] is inferred to be equal to 0.
mmdu_directional_lifting_delta_mean_num[tileID][patchIdx] specifies the difference of the mean numerator used to calculate z-score in the directional lifting, signalled for submesh with submesh ID mdu_submesh_id[tileID][patchIdx].
mmdu_directional_lifting_delta_mean_deno[tileID][patchIdx] specifies the difference of the mean denominator used to calculate z-score in the directional lifting, signalled for submesh with submesh ID mdu_submesh_id[tileID][patchIdx].
mmdu_directional_lifting_delta_std_num[tileID][patchIdx] specifies the difference of the standard deviation numerator used to calculate z-score in the directional lifting, signalled for submesh with submesh ID mdu_submesh_id[tileID][patchIdx].
mmdu_directional_lifting_delta_std_deno[tileID][patchIdx] specifies the difference of the standard deviation denominator used to calculate z-score in the directional lifting, signalled for submesh with submesh ID mdu_submesh_id[tileID][patchIdx].

Inter meshpatch data unit syntax

| | Descriptor |
|---|---|
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementIdPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] ){ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for(j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx ][ i ][ j ] | se(v) |
| [k] | |
| imdu_inverse_quantization_offset_value_log2_prec2_delta[ tileID ][ patchIdx ][ i ][ j ] | se(v) |
| [k] | |
| } | |
| } | |
| } | |
| } | |
| } | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] == 0 ) { | |
| if( InterPatchTransformMethod[ tileID ][ patchIdx ] == LINEAR_LIFTING && | |
| AspsLiftingOffsetPresentFlag ){ | |
| imdu_lifting_offset_present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] == LINEAR_LIFTING && | |
| AspsDirectionalLiftingPresentFlag ) { | |
| <add> imdu_directional_lifting_present_flag | u(1) |
| [ tileID ][ patchIdx ]</add> | |
| <add> if( imdu_directional_lifting_present_flag[ tileID ][ patchIdx ] ) {</add> | |
| <del> for( i = 0; i < 2; i++ ) {</del> | |
| <add> imdu_directional_lifting_delta_mean_num[ tileID ][ patchIdx ]</add> | se(v) |
| <add> imdu_directional_lifting_delta_mean_deno[ tileID ][ patchIdx ]</add> | se(v) |
| <del> imdu_directional_lifting_ scale_num[ tileID ][ patchIdx ][ i ]<del> | se(v) |
| <add> imdu_directional_lifting_delta_std_num[ tileID ][ patchIdx ] <add> | |
| <add> imdu_directional_lifting_delta_std_deno[ tileID ][ patchIdx ]</add> | se(v) |
| <del> }</de> | |
| <add> }</add> | |
| } | |
| if( InterPatchTransformMethod[ tileID ][ patchIdx ] == LINEAR_LIFTING && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_directional_lifting_present_flag[tileID][patchIdx] equal to 1 indicates that the directional lifting parameters are present for a meshpatch with index patchIdx, in the current atlas tile, with tile ID equal to tileID. imdu_directional_lifting_present_flag[tileID][patchIdx] equal to 0 indicates that the directional lifting parameters are not present. When not present, imdu_directional_lifting_present_flag[tileID][patchIdx] is inferred to be equal to 0.
imdu_directional_lifting_delta_mean_num[tileID][patchIdx] specifies the difference of the mean numerator used to calculate z-score in the directional lifting, signalled for submesh with submesh ID mdu_submesh_id[tileID][patchIdx].
imdu_directional_lifting_delta_mean_deno[tileID][patchIdx] specifies the difference of the mean denominator used to calculate z-score in the directional lifting, signalled for submesh with submesh ID mdu_submesh_id[tileID][patchIdx].
imdu_directional_lifting_delta_std_num[tileID][patchIdx] specifies the difference of the standard deviation numerator used to calculate z-score in the directional lifting, signalled for submesh with submesh ID mdu_submesh_id[tileID][patchIdx].
imdu_directional_lifting_delta_std_deno[tileID][patchIdx] specifies the difference of the standard deviation denominator used to calculate z-score in the directional lifting, signalled for submesh with submesh ID mdu_submesh_id[tileID][patchIdx].

Lifting offset and directional lifting disabled for 3-d displacement is now described. Lifting offset tool and directional lifting transform could be extended to 3 dimensional but currently are applicable only when displacement is 1-dimensional. Therefore, the aforementioned tools inability should be checked at an ASPS level as follows:

```
asps_vdmc_extension( ) {
  asve_subdivision_iteration_count
  AspsSubdivisionCount = asve_subdivision_iteration_count
  if( AspsSubdivisionCount > 1 ) {
    asve_lod_adaptive_subdivision_flag
  }
  asve_edge_based_subdivision_flag
  for( i=0; i < AspsSubdivisionCount ; i++) {
    if( asve_lod_adaptive_subdivision_flag == 1 || i == 0 ) {
      asve_subdivision_method[ i ]
    } else {
      asve_subdivision_method[ i ] = asve_subdivision_method[ 0 ]
    }
    AspsSubdivisionMethod[ i ] = asve_subdivision_method[ i ]
  }
  if( asve_edge_based_subdivision_flag == 1 ) {
    asve_subdivision_min_edge_length
    AspsSubdivisionMinEdgeLength = asve_subdivision_min_edge_length
  } else {
    AspsSubdivisionMinEdgeLength = 0
  }
  asve_1d_displacement_flag
  asve_interpolate_subdivided_normals_flag
  asve_displacement_reference_qp_minus49
  asve_quantization_parameters_present_flag
  if( asve_quantization_parameters_present_flag ) {
    asve_inverse_quantization_offset_present_flag
    vdmc_quantization_parameters( 0, AspsSubdivisionCount, 0)
  }
  if( AspsSubdivisionCount != 0 ) {
    asve_transform_method
    AspsTransformMethod = asve_transform_method
  }
  if(asve_1d_displacement_flag){
    asve_lifting_offset_present_flag
    asve_directional_lifting_present_flag
  }
  <add> if( asve_transform_method == LINEAR_LIFTING && AspsSubdivisionCount != 0 ) {
    vdmc_lifting_transform_parameters( 0, AspsSubdivisionCount )
  } </add>
  asve_attribute_information_present_flag
  if( asve_attribute_information_present_flag ) {
    asve_consistent_attribute_frame_flag
    if(!asve_consistent_attribute_frame_flag) {
      asve_attribute_frame_size_count
    }
    for(i=0; i< AspsAttributeNominalFrameSizeCount; i++){
      asve_attribute_frame_width[ i ]
      asve_attribute_frame_height[ i ]
      asve_attribute_subtexture_enabled_flag[ i ]
    }
  }
  asve_displacement_id_present_flag
  asve_lod_patches_enable_flag
  asve_packing_method
  asve_projection_texcoord_enable_flag
  if( asve_projection_texcoord_enable_flag ){
    asve_projection_texcoord_mapping_attribute_index_present_flag
    if( asve_projection_texcoord_mapping_attribute_index_present_flag ) {
      asve_projection_texcoord_mapping_attribute_index
    }
    asve_projection_texcoord_output_bit_depth_minus1
    asve_projection_texcoord_bbox_bias_enable_flag
    asve_projection_texcoord_upscale_factor_minus1
    asve_projection_texcoord_log2_downscale_factor
    asve_projection_raw_textcoord_present_flag
    if( asve_projection_raw_textcoord_present_flag )
      asve_projection_raw_textcoord_bitdepth_minus1
  }
  asve_vdmc_vui_parameters_present_flag
  if( asve_vdmc_vui_parameters_present_flag )
    vdmc_vui_parameters( )
}
```

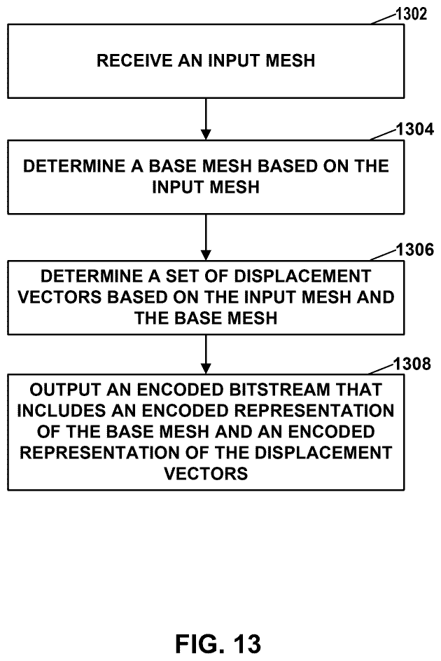

FIG. 13 is a flowchart illustrating an example process for encoding a mesh. Although described with respect to V-DMC encoder 200 (FIGS. 1 and 2), it should be understood that other devices may be configured to perform a process similar to that of FIG. 13.

In the example of FIG. 13, V-DMC encoder 200 receives an input mesh (1302). V-DMC encoder 200 determines a base mesh based on the input mesh (1304). V-DMC encoder 200 determines a set of displacement vectors based on the input mesh and the base mesh (1306). V-DMC encoder 200 outputs an encoded bitstream that includes an encoded representation of the base mesh and an encoded representation of the displacement vectors (1308). V-DMC encoder 200 may additionally determine attribute values from the input mesh and include an encoded representation of the attribute values vectors in the encoded bitstream.

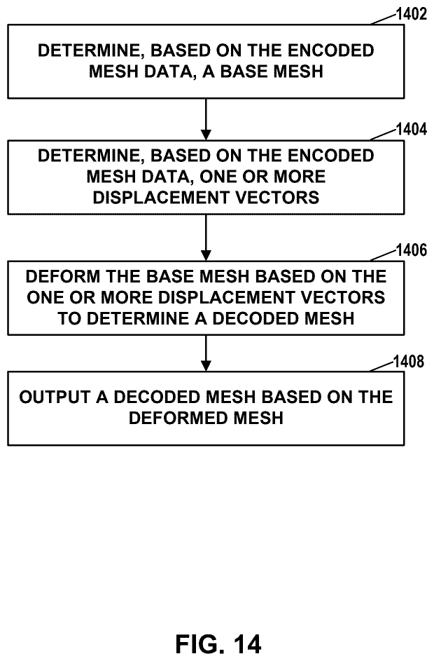

FIG. 14 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 14.

In the example of FIG. 14, V-DMC decoder 300 determines, based on the encoded mesh data, a base mesh (1402). V-DMC decoder 300 determines, based on the encoded mesh data, one or more displacement vectors (1404). V-DMC decoder 300 deforms the base mesh using the one or more displacement vectors (1406). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1408). V-DMC decoder 300 may, for example, output the decoded mesh for storage, transmission, or display.

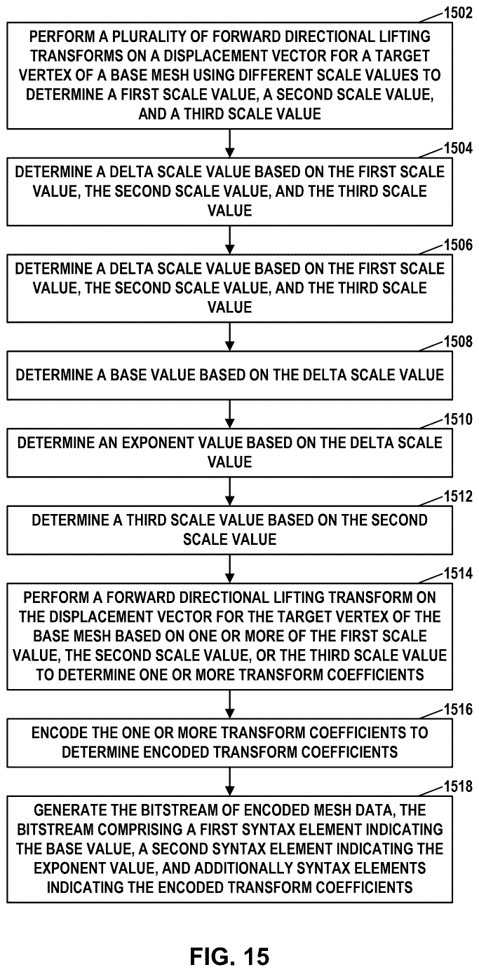

FIG. 15 is a flowchart illustrating an example process for encoding a mesh. Although described with respect to V-DMC encoder 200, processing circuitry of other devices may be configured to perform the techniques of this disclosure.

V-DMC encoder 200 performs a plurality of forward directional lifting transforms on a displacement vector for a target vertex of a base mesh using different scale values to determine a first scale value, a second scale value, and a third scale value (1502). In some examples, V-DMC encoder 200 may perform a rate-distortion optimization (RDO) process to select optimal values for the first scale value (e.g., scale1), the second scale value (e.g., scale2), and the third scale value (e.g., scale3) from a set of candidate values. The performance of the directional lifting transform may be sensitive to these thresholds, and determining optimal scales at the encoder allows for improved coding efficiency compared to using hard-coded thresholds at the decoder.

V-DMC encoder 200 determines a delta scale value based on the first scale value, the second scale value, and the third scale value (1504). To reduce metadata overhead, V-DMC encoder 200 may determine a single parameter, the delta scale value (e.g., Δscale), that relates the three scale values. For example, V-DMC encoder 200 may determine the delta scale value such that the first scale value equals one minus the delta scale value (scale1=1−Δscale). V-DMC encoder 200 may further confirm that the second scale value satisfies a relationship based on the first scale value and the delta scale value, such as scale2=scale1+(Δscale/2). V-DMC encoder 200 may also confirm that the third scale value satisfies a relationship based on the second scale value, such as scale3=scale2+(Δscale/3), scale3=scale2+(Δscale/2), or scale3=1.

V-DMC encoder 200 determines a base value based on the delta scale value (1508) and determines an exponent value based on the delta scale value (1510). Rather than signaling the full floating-point values for the scales, V-DMC encoder 200 calculates a base value (e.g., base) and an exponent value (e.g., exp) that represent the delta scale value. In some examples, V-DMC encoder 200 determines these values according to the relationship: Δscale=base+10^{-exp}. This representation allows V-DMC encoder 200 to signal the performance-sensitive thresholds efficiently using integer syntax elements.

V-DMC encoder 200 performs a forward directional lifting transform on the displacement vector for the target vertex of the base mesh based on one or more of the first scale value, the second scale value, or the third scale value to determine one or more transform coefficients (1514). V-DMC encoder 200 may utilize the selected scale values to adapt prediction and update weights used in the lifting transform. In some examples, V-DMC encoder 200 simplifies the calculation of these weights to avoid computationally expensive operations. For instance, V-DMC encoder 200 may calculate an update scale (Uscale) as k²−1 and a prediction scale (Pscale) as k¹−1, where k represents the selected scale value (e.g., scale1, scale2, or scale3). This simplification avoids two-step calculations involving multiple hard-coded constants found in other approaches.

V-DMC encoder 200 may selects the specific scale value (k) to apply to a given target vertex by calculating a deviation value (e.g., a Z-score numerator) and comparing the deviation value to a standard deviation associated with the mesh patch. V-DMC encoder 200 may simplify this comparison by comparing the absolute difference between the signal and the mean directly to multiples of the standard deviation (e.g., 1σ, 2σ), thereby avoiding a division operation for a Z-score calculation. V-DMC encoder 200 encodes the one or more transform coefficients to determine encoded transform coefficients (1516).

V-DMC encoder 200 generates the bitstream of encoded mesh data (1518). The bitstream includes a first syntax element indicating the base value (e.g., vltp_directional_lifting_scale_base) and a second syntax element indicating the exponent value (e.g., vltp_directional_lifting_scale_exp). The bitstream additionally includes syntax elements indicating the encoded transform coefficients. By signaling the base and exponent, V-DMC encoder 200 enables a decoder to reconstruct the delta scale value and subsequently derive the first, second, and third scale values required to inverse the directional lifting process.

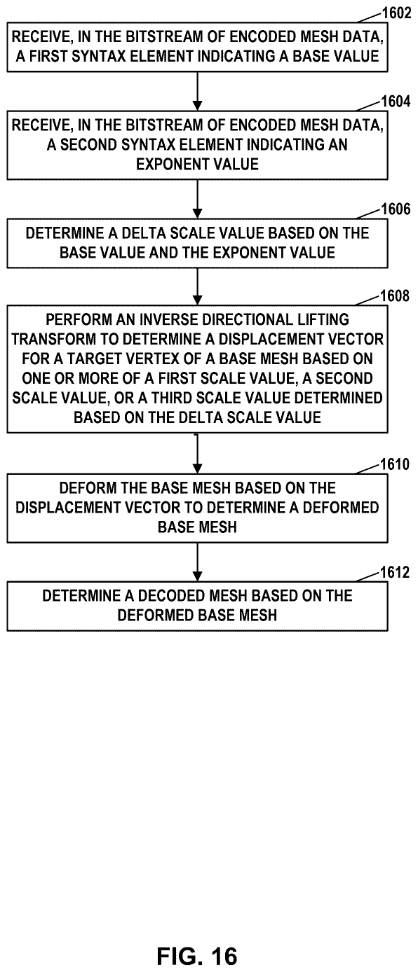

FIG. 16 is a flowchart illustrating an example process for decoding a compressed bitstream of mesh data. Although described with respect to V-DMC decoder 300 (FIGS. 1 and 3), processing circuitry of other devices may be configured to perform the process of FIG. 16.

In the example of FIG. 16, V-DMC decoder 300 receives, in the bitstream of encoded mesh data, a first syntax element indicating a base value (1602). V-DMC decoder 300 also receives, in the bitstream of encoded mesh data, a second syntax element indicating an exponent value (1604). These syntax elements may be received in a lifting transform parameter set, such as part of an Atlas Sequence Parameter Set (ASPS) or a mesh patch data unit. For example, the first syntax element may correspond to vltp_directional_lifting_scale_base, and the second syntax element may correspond to vltp_directional_lifting_scale_exp.

V-DMC decoder 300 determines a delta scale value based on the base value and the exponent value (1606). In some examples, V-DMC decoder 300 determines the delta scale value (e.g., Δscale) as follows: Δscale=base+10^{-exp}, where base represents the base value and exp represents the exponent value.

V-DMC decoder 300 determines a first scale value, a second scale value, and a third scale value based on the delta scale value. V-DMC decoder 300 may determine the first scale value (scale1) such that scale1 equals 1 minus the delta scale value (scale1=1−Δscale). V-DMC decoder 300 may determine the second scale value (scale2) such that scale2 equals the first scale value plus half of the delta scale value (scale2=scale1+Δscale/2). V-DMC decoder 300 may determine the third scale value (scale3) such that scale3 equals the second scale value plus a fraction of the delta scale value (e.g., scale3=scale2+Δscale/2 or scale3=scale2+Δscale/3).

V-DMC decoder 300 performs an inverse directional lifting transform to determine a displacement vector for a target vertex of a base mesh based on one or more of the first scale value, the second scale value, or the third scale value determined based on the delta scale value (1608). To perform the inverse directional lifting transform, V-DMC decoder 300 may determine a wavelet coefficient of the target vertex. Determining the wavelet coefficient may include demultiplexing a displacement sub-bitstream from the bitstream of encoded mesh data, decoding the displacement sub-bitstream to generate quantized wavelet coefficients, and applying inverse quantization to the quantized wavelet coefficients to determine the wavelet coefficient of the target vertex.

To apply the transform, V-DMC decoder 300 determines a deviation value for the wavelet coefficient of the target vertex based on a mean value associated with a mesh patch. Determining the deviation value may include determining an absolute difference between a first component of the wavelet coefficient of the target vertex and the mean value. V-DMC decoder 300 selects one of the first scale value, the second scale value, or the third scale value as a selected scale value based on a comparison of the deviation value to a standard deviation value associated with the mesh patch. For example, V-DMC decoder 300 may select the first scale value if the deviation value is less than the standard deviation value, select the second scale value if the deviation value is less than two times the standard deviation value, and select the third scale value otherwise. V-DMC decoder 300 applies the inverse directional lifting transform to the wavelet coefficient based on the selected scale value to determine the displacement vector.

V-DMC decoder 300 determines a coherence of the target vertex with respect to a first neighboring vertex and a second neighboring vertex. Determining the coherence may include comparing a first component of the first neighboring vertex to a first component of the second neighboring vertex. V-DMC decoder 300 determines an adaptive weight based on the selected scale value.

In a prediction step of the inverse directional lifting transform, V-DMC decoder 300 applies the adaptive weight to modify a contribution to the prediction step of one of the first neighboring vertex or the second neighboring vertex based on the coherence. V-DMC decoder 300 selects one of the first neighboring vertex or the second neighboring vertex as a selected neighboring vertex based on the coherence. V-DMC decoder 300 determines a weighted value based on multiplying a wavelet coefficient of the selected neighboring vertex with the adaptive weight and adds the weighted value to the wavelet coefficient of the target vertex.

In an update step of the inverse directional lifting transform, V-DMC decoder 300 applies the adaptive weight to modify a contribution to the update step of one of the first neighboring vertex or the second neighboring vertex based on the coherence. V-DMC decoder 300 selects one of the first neighboring vertex or the second neighboring vertex as a selected neighboring vertex based on the coherence. V-DMC decoder 300 determines a weighted value based on multiplying a wavelet coefficient of the target vertex with the adaptive weight and subtracts the weighted value from a wavelet coefficient of the selected neighboring vertex.

V-DMC decoder 300 deforms the base mesh based on the displacement vector to determine a deformed base mesh (1610). V-DMC decoder 300 determines a decoded mesh based on the deformed base mesh (1612). V-DMC decoder 300 may further determine attribute values for vertices of the decoded mesh. V-DMC decoder 300 may cause a display to present imagery based on the decoded mesh.
Clause 1A: A device for decoding encoded mesh data, the device comprising: one or more memory units; one or more processing units implemented in circuitry, coupled to the one or more memory units, and configured to: determine, based on the encoded mesh data, a base mesh with a first set of vertices; subdivide the base mesh to determine an additional set of vertices for the base mesh; determine one or more displacement vectors according to any technique of this disclosure; deform the base mesh, wherein to deform the base mesh, the one or more processing units are configured to modify locations of the additional set of vertices based on the one or more displacement vectors; and determine a decoded mesh based on the deformed base mesh.
Clause 2A. The device of clause 1A, wherein the one or more processing units are further configured to determine attribute values for vertices of the decoded mesh.
Clause 3A. A device for encoding encoded mesh data, the device comprising: one or more memory units; and one or more processing units implemented in circuitry, coupled to the one or more memory units, and configured to: receive an input mesh; determine a base mesh based on the input mesh; determine a set of displacement vectors based on the input mesh and the base mesh according to any technique of this disclosure; and output an encoded bitstream that includes an encoded representation of the base mesh and an encoded representation of the displacement vectors according to any technique of this disclosure.
Clause 4A. The device of clause 3A, wherein the one or more processing units are further configured to determine a set of attribute values for the input mesh and include an encoded representation of the attribute values in the encoded bitstream.
Clause 5A. A method of decoding encoded mesh data, the method comprising: determining, based on the encoded mesh data, a base mesh with a first set of vertices; subdividing the base mesh to determine an additional set of vertices for the base mesh; determining one or more displacement vectors according to any technique of this disclosure; deforming the base mesh, wherein deforming the base mesh comprising modifying locations of the additional set of vertices based on the one or more displacement vectors; and determining a decoded mesh based on the deformed base mesh.
Clause 6A. The method of clause 5A, further comprising determining attribute values for vertices of the decoded mesh.
Clause 7A. A method of encoding encoded mesh data, the method comprising: receiving an input mesh; determining a base mesh based on the input mesh; determining a set of displacement vectors based on the input mesh and the base mesh according to any technique of this disclosure; and outputting an encoded bitstream that includes an encoded representation of the base mesh and an encoded representation of the displacement vectors according to any technique of this disclosure.
Clause 8A. The method of clause 7A, further comprising determining a set of attribute values for the input mesh and include an encoded representation of the attribute values in the encoded bitstream.
Clause 9A. Computer-readable storage media storing instructions thereon that when executed cause one or more processors to perform the method of any of clauses 5A-8A.
Clause 1B: A device for decoding a bitstream of encoded mesh data, the device comprising: one or more memory units; one or more processing units implemented in circuitry, coupled to the one or more memory units, and configured to: receive, in the bitstream of encoded mesh data, a first syntax element indicating a base value; receive, in the bitstream of encoded mesh data, a second syntax element indicating an exponent value; determine a delta scale value based on the base value and the exponent value; perform an inverse directional lifting transform to determine a displacement vector for a target vertex of a base mesh based on one or more of a first scale value, a second scale value, or a third scale value determined based on the delta scale value; deform the base mesh based on the displacement vector to determine a deformed base mesh; and determine a decoded mesh based on the deformed base mesh.
Clause 2B: The device of clause 1B, wherein the one or more processing units are configured to: determine a deviation value for a wavelet coefficient of the target vertex based on a mean value associated with a mesh patch; and select one of the first scale value, the second scale value, or the third scale value as a selected scale value based on a comparison of the deviation value to a standard deviation value associated with the mesh patch, wherein to perform the inverse directional lifting transform, the one or more processing units are configured to apply the inverse directional lifting transform to the wavelet coefficient based on the selected scale value to determine the displacement vector for the target vertex of the base mesh.
Clause 3B: The device of clause 2B, wherein to apply the inverse directional lifting transform to the wavelet coefficient based on the selected scale value, the one or more processing units are configured to: determine a coherence of the target vertex with respect to a first neighboring vertex and a second neighboring vertex; determine an adaptive weight based on the selected scale value; and apply the adaptive weight to a prediction step of the inverse directional lifting transform to modify a contribution to the prediction step of one of the first neighboring vertex or the second neighboring vertex based on the coherence.
Clause 4B: The device of clause 3B, wherein to apply the adaptive weight to the prediction step of the inverse directional lifting transform, the one or more processing units are configured to: select one of the first neighboring vertex or the second neighboring vertex as a selected neighboring vertex based on the coherence; determine a weighted value based on multiplying a wavelet coefficient of the selected neighboring vertex with the adaptive weight; and add the weighted value to the wavelet coefficient of the target vertex.
Clause 5B: The device of clause 2B, wherein to apply the inverse directional lifting transform to the wavelet coefficient based on the selected scale value, the one or more processing units are configured to: determine a coherence of the target vertex with respect to a first neighboring vertex and a second neighboring vertex; determine an adaptive weight based on the selected scale value; and apply the adaptive weight to an update step of the inverse directional lifting transform to modify a contribution to the update step of one of the first neighboring vertex or the second neighboring vertex based on the coherence.
Clause 6B: The device of clause 5B, wherein to apply the adaptive weight to the update step of the inverse directional lifting transform, the one or more processing units are configured to: select one of the first neighboring vertex or the second neighboring vertex as a selected neighboring vertex based on the coherence; determine a weighted value based on multiplying a wavelet coefficient of the target vertex with the adaptive weight; and subtract the weighted value from a wavelet coefficient of the selected neighboring vertex.
Clause 7B: The device of any of clauses 2B-6B, wherein the one or more processing units are further configured to determine the wavelet coefficient of the target vertex by: demultiplexing a displacement sub-bitstream from the bitstream of encoded mesh data; decoding the displacement sub-bitstream to generate quantized wavelet coefficients; and applying inverse quantization to the quantized wavelet coefficients to determine the wavelet coefficient of the target vertex.
Clause 8B: The device of any of clauses 2B-7B, wherein to determine the deviation value for the wavelet coefficient of the target vertex, the one or more processing units are configured to determine an absolute difference between a first component of the wavelet coefficient of the target vertex and the mean value associated with the mesh patch.
Clause 9B: The device of any of clauses 1B-8B, wherein to determine the delta scale value based on the base value and the exponent value, the one or more processing units are configured to determine the delta scale value as follows: Δscale=base+10^{-exp}, wherein Δscale equals the delta scale value, base equals the base value, and exp equals the exponent value.
Clause 10B: The device of any of clauses 1B-9B, wherein to determine the first scale value based on the delta scale value, the one or more processing units are configured to determine the first scale value as follows: scale1=1−Δscale wherein scale1 equals the first scale value.
Clause 11B: The device of any of clauses 1B-10B, wherein to determine the second scale value based on the delta scale value, the one or more processing units are configured to determine the second scale value as follows:

$$scale 2 = scale 1 + \frac{Δ s c a l e}{2} ,$$

wherein scale2 equals the second scale value.
Clause 12B: The device of clause 11B, wherein to determine the third scale value based on the delta scale value, the one or more processing units are configured to determine the third scale value as follows:

$$scale 3 = scale 2 + \frac{Δ scale}{X} ,$$

wherein scale3 equals the third scale value and x equals one of 2 or 3.
Clause 13B: The device of any of clauses 1B-12B, further comprising a display to present imagery based on the decoded mesh.
Clause 14B: A method of decoding a bitstream of encoded mesh data, the method comprising: receiving, in the bitstream of encoded mesh data, a first syntax element indicating a base value; receiving, in the bitstream of encoded mesh data, a second syntax element indicating an exponent value; determining a delta scale value based on the base value and the exponent value; performing an inverse directional lifting transform to determine a displacement vector for a target vertex of a base mesh based on one or more of a first scale value, a second scale value, or a third scale value determined based on the delta scale value; deforming the base mesh based on the displacement vector to determine a deformed base mesh; and determining a decoded mesh based on the deformed base mesh.
Clause 15B: The method of clause 14B, further comprising: determining a deviation value for a wavelet coefficient of the target vertex based on a mean value associated with a mesh patch; and selecting one of the first scale value, the second scale value, or the third scale value as a selected scale value based on a comparison of the deviation value to a standard deviation value associated with the mesh patch, wherein performing the inverse directional lifting transform comprises applying the inverse directional lifting transform to the wavelet coefficient based on the selected scale value to determine the displacement vector for the target vertex of the base mesh.
Clause 16B: The method of clause 15B, wherein applying the inverse directional lifting transform to the wavelet coefficient based on the selected scale value comprises: determining a coherence of the target vertex with respect to a first neighboring vertex and a second neighboring vertex; determining an adaptive weight based on the selected scale value; and applying the adaptive weight to a prediction step of the inverse directional lifting transform to modify a contribution to the prediction step of one of the first neighboring vertex or the second neighboring vertex based on the coherence.
Clause 17B: The method of clause 16B, wherein applying the adaptive weight to the prediction step of the inverse directional lifting transform comprises: selecting one of the first neighboring vertex or the second neighboring vertex as a selected neighboring vertex based on the coherence; determining a weighted value based on multiplying a wavelet coefficient of the selected neighboring vertex with the adaptive weight; and adding the weighted value to the wavelet coefficient of the target vertex.
Clause 18B: The method of clause 15B, wherein applying the inverse directional lifting transform to the wavelet coefficient based on the selected scale value comprises: determining a coherence of the target vertex with respect to a first neighboring vertex and a second neighboring vertex; determining an adaptive weight based on the selected scale value; and applying the adaptive weight to an update step of the inverse directional lifting transform to modify a contribution to the update step of one of the first neighboring vertex or the second neighboring vertex based on the coherence.
Clause 19B: The method of clause 18B, wherein applying the adaptive weight to the update step of the inverse directional lifting transform comprises: selecting one of the first neighboring vertex or the second neighboring vertex as a selected neighboring vertex based on the coherence; determining a weighted value based on multiplying a wavelet coefficient of the target vertex with the adaptive weight; and subtracting the weighted value from a wavelet coefficient of the selected neighboring vertex.
Clause 20B: The method of any of clauses 15B-19B, further comprising determining the wavelet coefficient of the target vertex by: demultiplexing a displacement sub-bitstream from the bitstream of encoded mesh data; decoding the displacement sub-bitstream to generate quantized wavelet coefficients; and applying inverse quantization to the quantized wavelet coefficients to determine the wavelet coefficient of the target vertex.
Clause 21B: The method of any of clauses 15B-20B, wherein determining the deviation value for the wavelet coefficient of the target vertex comprises determining an absolute difference between a first component of the wavelet coefficient of the target vertex and the mean value associated with the mesh patch.
Clause 22B: The method of any of clauses 14B-20B, wherein determining the delta scale value based on the base value and the exponent value comprises determining the delta scale value as follows: Δscale=base+10^{-exp}, wherein Δscale equals the delta scale value, base equals the base value, and exp equals the exponent value.
Clause 23B: The method of any of clauses 14B-22B, wherein determining the first scale value based on the delta scale value comprises determining the first scale value as follows: scale1=1−Δscale wherein scale1 equals the first scale value.
Clause 24B: The method of clause 23B, wherein determining the second scale value based on the delta scale value comprises determining the second scale value as follows:

$$scale 2 = scale 1 + \frac{Δ scale}{2} ,$$

wherein scale2 equals the second scale value.
Clause 25B: The method of clause 24B, wherein determining the third scale value based on the delta scale value comprises determining the third scale value as follows:

$$scale 3 = scale 2 + \frac{Δ scale}{X} ,$$

wherein scale2 equals the third scale value and x equals one of 2 or 3.
Clause 26B: A non-transitory computer-readable medium storing instructions that, when executed by processing circuitry, cause the processing circuitry to: receive, in a bitstream of encoded mesh data, a first syntax element indicating a base value; receive, in the bitstream of encoded mesh data, a second syntax element indicating an exponent value; determine a delta scale value based on the base value and the exponent value; perform an inverse directional lifting transform to determine a displacement vector for a target vertex of a base mesh based on one or more of a first scale value, a second scale value, or a third scale value determined based on the delta scale value; deform the base mesh based on the displacement vector to determine a deformed base mesh; and determine a decoded mesh based on the deformed base mesh.
Clause 27B: The non-transitory computer-readable medium of clause 26B, wherein to determine the displacement vector based on the first scale value, the second scale value, and the third scale value, the processing circuitry is further configured to: determine a deviation value for a wavelet coefficient of the target vertex based on a mean value associated with a mesh patch; select one of the first scale value, the second scale value, or the third scale value as a selected scale value based on a comparison of the deviation value to a standard deviation value associated with the mesh patch; and apply the inverse directional lifting transform to the wavelet coefficient based on the selected scale value, wherein to apply the inverse directional lifting transform to the wavelet coefficient based on the selected scale value, the processing circuitry is further configured to: determine a coherence of the target vertex with respect to a first neighboring vertex and a second neighboring vertex; determine an adaptive weight based on the selected scale value; and apply the adaptive weight to a prediction step of the inverse directional lifting transform to modify a contribution from one of the first neighboring vertex or the second neighboring vertex based on the coherence.
Clause 28B: The non-transitory computer-readable medium of clause 27B, wherein to determine the delta scale value based on the base value and the exponent value, determine the first scale value based on the delta scale value, determine the second scale value based on the delta scale value, determine the third scale value based on the delta scale value, the processing circuitry is further configured to determine the delta scale value, the first scale value, the second scale value, and the third scale value as follows: Δscale=base+^{10-exp}, wherein Δscale equals the delta scale value, base equals the base value, and exp equals the exponent value; scale1=1−Δscale, wherein scale1 equals the first scale value;

$$scale 2 = scale 1 + \frac{Δ scale}{2} ,$$

wherein scale2 equals the second scale value;

$$scale 3 = scale 2 + \frac{Δ scale}{X} ,$$

and wherein scale3 equals the third scale value, and x equals one of 2 or 3.
Clause 29B: A device for generating a bitstream of encoded mesh data, the device comprising: one or more memory units; one or more processing units implemented in circuitry, coupled to the one or more memory units, and configured to: perform a plurality of forward directional lifting transforms on a displacement vector for a target vertex of a base mesh using different scale values to determine a first scale value, a second scale value, and a third scale value; determine a delta scale value based on the first scale value, the second scale value, and the third scale value; determine a base value based on the delta scale value; determine an exponent value based on the delta scale value; perform a forward directional lifting transform on the displacement vector for the target vertex of the base mesh based on one or more of the first scale value, the second scale value, or the third scale value to determine one or more transform coefficients; encode the one or more transform coefficients to determine encoded transform coefficients; and generate the bitstream of encoded mesh data, the bitstream comprising a first syntax element indicating the base value, a second syntax element indicating the exponent value, and additionally syntax elements indicating the encoded transform coefficients.
Clause 30B: The device of clause 29B, wherein to determine the delta scale value based on the first scale value, the second scale value, and the third scale value, the one or more processing units are configured to determine the delta scale value in accordance with the following: Δscale=base+10^{-exp}, wherein Δscale equals the delta scale value, base equals the base value, and exp equals the exponent value; scale1=1−Δscale, wherein scale1 equals the first scale value;

$$scale 2 = scale 1 + \frac{Δ scale}{2} ,$$

wherein scale2 equals the second scale value; and

$$scale 3 = scale 2 + \frac{Δ scale}{X} ,$$

wherein scale3 equals the third scale value, and x equals one of 2 or 3.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding a bitstream of encoded mesh data, the device comprising:
one or more memory units;
one or more processing units implemented in circuitry, coupled to the one or more memory units, and configured to:
receive, in the bitstream of encoded mesh data, a first syntax element indicating a base value;
receive, in the bitstream of encoded mesh data, a second syntax element indicating an exponent value;
determine a delta scale value based on the base value and the exponent value;
perform an inverse directional lifting transform to determine a displacement vector for a target vertex of a base mesh based on one or more of a first scale value, a second scale value, or a third scale value determined based on the delta scale value;
deform the base mesh based on the displacement vector to determine a deformed base mesh; and
determine a decoded mesh based on the deformed base mesh.

2. The device of claim 1, wherein the one or more processing units are configured to:
determine a deviation value for a wavelet coefficient of the target vertex based on a mean value associated with a mesh patch; and
select one of the first scale value, the second scale value, or the third scale value as a selected scale value based on a comparison of the deviation value to a standard deviation value associated with the mesh patch,
wherein to perform the inverse directional lifting transform, the one or more processing units are configured to apply the inverse directional lifting transform to the wavelet coefficient based on the selected scale value to determine the displacement vector for the target vertex of the base mesh.

3. The device of claim 2, wherein to apply the inverse directional lifting transform to the wavelet coefficient based on the selected scale value, the one or more processing units are configured to:
determine a coherence of the target vertex with respect to a first neighboring vertex and a second neighboring vertex;
determine an adaptive weight based on the selected scale value; and
apply the adaptive weight to a prediction step of the inverse directional lifting transform to modify a contribution to the prediction step of one of the first neighboring vertex or the second neighboring vertex based on the coherence.

4. The device of claim 3, wherein to apply the adaptive weight to the prediction step of the inverse directional lifting transform, the one or more processing units are configured to:
select one of the first neighboring vertex or the second neighboring vertex as a selected neighboring vertex based on the coherence;
determine a weighted value based on multiplying a wavelet coefficient of the selected neighboring vertex with the adaptive weight; and
add the weighted value to the wavelet coefficient of the target vertex.

5. The device of claim 2, wherein to apply the inverse directional lifting transform to the wavelet coefficient based on the selected scale value, the one or more processing units are configured to:
determine a coherence of the target vertex with respect to a first neighboring vertex and a second neighboring vertex;
determine an adaptive weight based on the selected scale value; and
apply the adaptive weight to an update step of the inverse directional lifting transform to modify a contribution to the update step of one of the first neighboring vertex or the second neighboring vertex based on the coherence.

6. The device of claim 5, wherein to apply the adaptive weight to the update step of the inverse directional lifting transform, the one or more processing units are configured to:
select one of the first neighboring vertex or the second neighboring vertex as a selected neighboring vertex based on the coherence;
determine a weighted value based on multiplying a wavelet coefficient of the target vertex with the adaptive weight; and
subtract the weighted value from a wavelet coefficient of the selected neighboring vertex.

7. The device of claim 2, wherein the one or more processing units are further configured to determine the wavelet coefficient of the target vertex by:
demultiplexing a displacement sub-bitstream from the bitstream of encoded mesh data;
decoding the displacement sub-bitstream to generate quantized wavelet coefficients; and
applying inverse quantization to the quantized wavelet coefficients to determine the wavelet coefficient of the target vertex.

8. The device of claim 2, wherein to determine the deviation value for the wavelet coefficient of the target vertex, the one or more processing units are configured to determine an absolute difference between a first component of the wavelet coefficient of the target vertex and the mean value associated with the mesh patch.

9. The device of claim 1, wherein to determine the delta scale value based on the base value and the exponent value, the one or more processing units are configured to determine the delta scale value as follows:
Δscale=base+10^{-exp}, wherein Δscale equals the delta scale value, base equals the base value, and exp equals the exponent value.

10. The device of claim 1, wherein to determine the first scale value based on the delta scale value, the one or more processing units are configured to determine the first scale value as follows:
scale1=1−Δscale wherein scale1 equals the first scale value.

11. The device of claim 10, wherein to determine the second scale value based on the delta scale value, the one or more processing units are configured to determine the second scale value as follows:
$$scale 2 = scale 1 + \frac{Δ scale}{2} ,$$
wherein scale2 equals the second scale value.

12. The device of claim 11, wherein to determine the third scale value based on the delta scale value, the one or more processing units are configured to determine the third scale value as follows:
$$scale 3 = scale 2 + \frac{Δ scale}{X} ,$$
wherein scale3 equals the third scale value and x equals one of 2 or 3.

13. The device of claim 1, further comprising a display to present imagery based on the decoded mesh.

14. A method of decoding a bitstream of encoded mesh data, the method comprising:
receiving, in the bitstream of encoded mesh data, a first syntax element indicating a base value;
receiving, in the bitstream of encoded mesh data, a second syntax element indicating an exponent value;
determining a delta scale value based on the base value and the exponent value;
performing an inverse directional lifting transform to determine a displacement vector for a target vertex of a base mesh based on one or more of a first scale value, a second scale value, or a third scale value determined based on the delta scale value;
deforming the base mesh based on the displacement vector to determine a deformed base mesh; and
determining a decoded mesh based on the deformed base mesh.

15. The method of claim 14, further comprising:
determining a deviation value for a wavelet coefficient of the target vertex based on a mean value associated with a mesh patch; and
selecting one of the first scale value, the second scale value, or the third scale value as a selected scale value based on a comparison of the deviation value to a standard deviation value associated with the mesh patch,
wherein performing the inverse directional lifting transform comprises applying the inverse directional lifting transform to the wavelet coefficient based on the selected scale value to determine the displacement vector for the target vertex of the base mesh.

16. The method of claim 15, wherein applying the inverse directional lifting transform to the wavelet coefficient based on the selected scale value comprises:
determining a coherence of the target vertex with respect to a first neighboring vertex and a second neighboring vertex;
determining an adaptive weight based on the selected scale value; and
applying the adaptive weight to a prediction step of the inverse directional lifting transform to modify a contribution to the prediction step of one of the first neighboring vertex or the second neighboring vertex based on the coherence.

17. The method of claim 16, wherein applying the adaptive weight to the prediction step of the inverse directional lifting transform comprises:
selecting one of the first neighboring vertex or the second neighboring vertex as a selected neighboring vertex based on the coherence;
determining a weighted value based on multiplying a wavelet coefficient of the selected neighboring vertex with the adaptive weight; and
adding the weighted value to the wavelet coefficient of the target vertex.

18. The method of claim 15, wherein applying the inverse directional lifting transform to the wavelet coefficient based on the selected scale value comprises:
determining a coherence of the target vertex with respect to a first neighboring vertex and a second neighboring vertex;
determining an adaptive weight based on the selected scale value; and
applying the adaptive weight to an update step of the inverse directional lifting transform to modify a contribution to the update step of one of the first neighboring vertex or the second neighboring vertex based on the coherence.

19. The method of claim 18, wherein applying the adaptive weight to the update step of the inverse directional lifting transform comprises:
selecting one of the first neighboring vertex or the second neighboring vertex as a selected neighboring vertex based on the coherence;
determining a weighted value based on multiplying a wavelet coefficient of the target vertex with the adaptive weight; and
subtracting the weighted value from a wavelet coefficient of the selected neighboring vertex.

20. The method of claim 15, further comprising determining the wavelet coefficient of the target vertex by:
demultiplexing a displacement sub-bitstream from the bitstream of encoded mesh data;
decoding the displacement sub-bitstream to generate quantized wavelet coefficients; and
applying inverse quantization to the quantized wavelet coefficients to determine the wavelet coefficient of the target vertex.

21. The method of claim 15, wherein determining the deviation value for the wavelet coefficient of the target vertex comprises determining an absolute difference between a first component of the wavelet coefficient of the target vertex and the mean value associated with the mesh patch.

22. The method of claim 14, wherein determining the delta scale value based on the base value and the exponent value comprises determining the delta scale value as follows:
Δscale=base+10^{-exp}, wherein Δscale equals the delta scale value, base equals the base value, and exp equals the exponent value.

23. The method of claim 14, wherein determining the first scale value based on the delta scale value comprises determining the first scale value as follows:
scale1=1−Δscale wherein scale1 equals the first scale value.

24. The method of claim 23, wherein determining the second scale value based on the delta scale value comprises determining the second scale value as follows:
$$scale 2 = scale 1 + \frac{Δ scale}{2} ,$$
wherein scale2 equals the second scale value.

25. The method of claim 24, wherein determining the third scale value based on the delta scale value comprises determining the third scale value as follows:
$$scale 3 = scale 2 + \frac{Δ scale}{X} ,$$
wherein scale3 equals the third scale value, and x equals one of 2 or 3.

26. A non-transitory computer-readable medium storing instructions that, when executed by processing circuitry, cause the processing circuitry to:
receive, in a bitstream of encoded mesh data, a first syntax element indicating a base value;
receive, in the bitstream of encoded mesh data, a second syntax element indicating an exponent value;
determine a delta scale value based on the base value and the exponent value;
perform an inverse directional lifting transform to determine a displacement vector for a target vertex of a base mesh based on one or more of a first scale value, a second scale value, or a third scale value determined based on the delta scale value;
deform the base mesh based on the displacement vector to determine a deformed base mesh; and
determine a decoded mesh based on the deformed base mesh.

27. The non-transitory computer-readable medium of claim 26, wherein to determine the displacement vector based on the first scale value, the second scale value, and the third scale value, the processing circuitry is further configured to:
determine a deviation value for a wavelet coefficient of the target vertex based on a mean value associated with a mesh patch;
select one of the first scale value, the second scale value, or the third scale value as a selected scale value based on a comparison of the deviation value to a standard deviation value associated with the mesh patch; and
apply the inverse directional lifting transform to the wavelet coefficient based on the selected scale value, wherein to apply the inverse directional lifting transform to the wavelet coefficient based on the selected scale value, the processing circuitry is further configured to:
determine a coherence of the target vertex with respect to a first neighboring vertex and a second neighboring vertex;
determine an adaptive weight based on the selected scale value; and
apply the adaptive weight to a prediction step of the inverse directional lifting transform to modify a contribution from one of the first neighboring vertex or the second neighboring vertex based on the coherence.

28. The non-transitory computer-readable medium of claim 27, wherein to determine the delta scale value based on the base value and the exponent value, determine the first scale value based on the delta scale value, determine the second scale value based on the delta scale value, determine the third scale value based on the delta scale value, the processing circuitry is further configured to determine the delta scale value, the first scale value, the second scale value, and the third scale value as follows:
Δscale=base+10^{-exp}, wherein Δscale equals the delta scale value, base equals the base value, and exp equals the exponent value;
scale1=1−Δscale, wherein scale1 equals the first scale value;
$$scale 2 = scale 1 + \frac{Δ scale}{2} ,$$
wherein scale2 equals the second scale value; and
$$scale 3 = scale 2 + \frac{Δ scale}{X} ,$$
wherein scale3 equals the third scale value, and x equals one of 2 or 3.

29. A device for generating a bitstream of encoded mesh data, the device comprising:
one or more memory units;
one or more processing units implemented in circuitry, coupled to the one or more memory units, and configured to:
perform a plurality of forward directional lifting transforms on a displacement vector for a target vertex of a base mesh using different scale values to determine a first scale value, a second scale value, and a third scale value;
determine a delta scale value based on the first scale value, the second scale value, and the third scale value;
determine a base value based on the delta scale value;
determine an exponent value based on the delta scale value;
perform a forward directional lifting transform on the displacement vector for the target vertex of the base mesh based on one or more of the first scale value, the second scale value, or the third scale value to determine one or more transform coefficients;
encode the one or more transform coefficients to determine encoded transform coefficients; and
generate the bitstream of encoded mesh data, the bitstream comprising a first syntax element indicating the base value, a second syntax element indicating the exponent value, and additionally syntax elements indicating the encoded transform coefficients.

30. The device of claim 29, wherein to determine the delta scale value based on the first scale value, the second scale value, and the third scale value, the one or more processing units are configured to determine the delta scale value in accordance with the following:
Δscale=base+10^{-exp}, wherein Δscale equals the delta scale value, base equals the base value, and exp equals the exponent value;
scale1=1−Δscale, wherein scale1 equals the first scale value;
$$scale 2 = scale 1 + \frac{Δ scale}{2} ,$$
wherein scale2 equals the second scale value; and
$$scale 3 = scale 2 + \frac{Δ scale}{X} ,$$
wherein scale3 equals the third scale value, and x equals one of 2 or 3.
